(19) United States
(12) Patent Application Publication
(10) Pub. No.: US 2022/0019813 A1
(43) Pub. Date: Jan. 20, 2022

(54) INFORMATION PROCESSING DEVICE, INFORMATION PROCESSING SYSTEM, AND INFORMATION PROCESSING METHOD

(71) Applicant: SONY GROUP CORPORATION, TOKYO (JP)

(72) Inventors: RYUTA SATOH, TOKYO (JP); YUSUKE HIEIDA, TOKYO (JP); YUKI YAMAMOTO, TOKYO (JP); KEITARO YAMAMOTO, TOKYO (JP); SEUNGHA YANG, TOKYO (JP)

(21) Appl. No.: 17/309,362

(22) PCT Filed: Nov. 21, 2019
(86) PCT No.: PCT/JP2019/045696

§ 371 Date: May 21, 2021

(30) Foreign Application Priority Data
Nov. 30, 2018 (JP) 2018-224881

(51) Int. Cl. G06K 9/00

(52) U.S. Cl. CPC G06K 9/00791

(57) ABSTRACT

A device and a method that enable safe driving by performing object recognition using image analysis and inter-vehicle communication information are implemented. Provided are an image analysis unit that analyzes an image captured by a vehicle-mounted camera and performs object recognition in the image, an unknown object identification unit that identifies an unknown object in an image area determined to be an unknown object area as a result of analysis by the image analysis unit, and a communication unit that transmits information to an unknown object such as a second vehicle identified by the unknown object identification unit. The unknown object identification unit identifies the second vehicle, which is an unknown object in the image area determined to be the unknown object area, using the peripheral object information received through the communication unit. The communication unit transmits unknown object information or control information for travel control of the second vehicle to the second vehicle.

### TECHNICAL FIELD

The present disclosure relates to an information processing device, an information processing system, and an information processing method. More specifically, the present disclosure relates to an information processing device, an information processing system, and an information processing method that enable safe driving of a moving device such as a vehicle, by performing object recognition using analysis information of an image captured by a camera mounted on the moving device such as a vehicle and communication information exchanged between moving devices.

### BACKGROUND ART

For safe driving of vehicles, technologies for detecting and recognizing an object on a traveling path by analyzing an image captured by a camera provided in the vehicle are being actively developed.

For example, there is semantic segmentation as a technology for recognizing an object in a captured image. Semantic segmentation is a technology for recognizing which object category, such as car or person, each constituent pixel of an image belongs to, on the basis of the degree of match between dictionary data (learned data) for object recognition based on the shape and other feature information of various actual objects and an object in the image. However, as a drawback of this object recognition processing, there is a problem that it becomes difficult or impossible to recognize an unregistered object having a shape or feature that is not registered in the dictionary.

On the other hand, various proposals have been made for a technology for communicating between vehicles and controlling traveling of the vehicle on the basis of information received from other vehicles.

For example, Patent Document 1 (Japanese Patent Application Laid-Open No. 2013-25423) discloses a configuration in which position information is transmitted and received among multiple vehicles traveling in a formation to maintain a predetermined interval.

However, this technology only discloses a configuration for maintaining the distance between vehicles by applying communication information exchanged between vehicles included in a limited formation, and does not disclose a configuration for recognizing unknown objects existing in front of the vehicle.

### CITATION LIST

### Patent Document

Patent Document 1: Japanese Patent Application Laid-Open No. 2013-25423

### SUMMARY OF THE INVENTION

### Problems to be Solved by the Invention

An object of the present disclosure is to provide an information processing device, an information processing system, and an information processing method that enable more reliable object recognition and safe driving of a moving device, by performing object recognition using analysis of an image captured by a camera mounted on a moving device such as a vehicle and communication information exchanged between the moving devices.

### Solutions to Problems

A first aspect of the present disclosure is

an information processing device including:

an image analysis unit that analyzes an image captured by a camera mounted on a moving device and performs object recognition in the image;

an unknown object identification unit that identifies an unknown object in an image area determined to be an unknown object area as a result of analysis by the image analysis unit; and

a communication unit that transmits information to an unknown object identified by the unknown object identification unit, in which

the unknown object identification unit identifies an unknown object in an image area determined to be an unknown object area by using peripheral object information received through the communication unit.

Moreover, a second aspect of the present disclosure is

an information processing device including:

an own position acquisition unit that acquires a current position of a moving device;

a communication unit that transmits moving device information including own position information acquired by the own position acquisition unit; and

a communication control unit that, upon receipt of unknown object information through the communication unit, changes a mode of transmitting moving device information through the communication unit.

Moreover, a third aspect of the present disclosure is

an information processing system including

a management server that generates and updates a dynamic map that reflects traffic information on a map, and

a moving device that refers to the dynamic map, in which

the management server performs map update processing for recording details of an unknown object on the dynamic map on the basis of unknown object information transmitted by the moving device, and

the moving device is allowed to confirm details of the unknown object by referring to the updated dynamic map.

Moreover, a fourth aspect of the present disclosure is

an information processing method performed by an information processing device, the method including:

an image analysis step in which an image analysis unit analyzes an image captured by a camera mounted on a moving device and performs object recognition in the image;

an unknown object identification step in which an unknown object identification unit identifies an unknown object in an image area determined to be an unknown object area as a result of analysis by the image analysis unit; and

a communication step in which a communication unit transmits information to an unknown object identified by the unknown object identification unit, in which

the unknown object identification step identifies an unknown object in an image area determined to be an unknown object area by using peripheral object information received through the communication unit.

Moreover, a fifth aspect of the present disclosure is

an information processing method performed by an information processing device, the method including:

an own position acquisition step in which an own position acquisition unit acquires a current position of a moving device;

a communication step in which a communication unit transmits moving device information including own position information acquired by the own position acquisition unit; and

a communication control step in which, upon receipt of unknown object information through the communication unit, a communication control unit changes a mode of transmitting moving device information through the communication unit.

Moreover, a sixth aspect of the present disclosure is

an information processing method performed by an information processing device, the method including:

an own position acquisition step in which an own position acquisition unit acquires a current position of a moving device;

a communication step in which a communication unit transmits moving device information including own position information acquired by the own position acquisition unit; and

a moving device control step in which, upon receipt of unknown object information or moving device control information through the communication unit, a moving device control unit performs movement control of the moving device.

Still other objectives, features and advantages of the present disclosure will become apparent by more detailed description based on examples of the present disclosure and accompanying drawings described below. Note that in the present specification, a system is a logical set configuration of multiple devices, and the devices having the configurations do not necessarily have to be in the same housing.

### Effects of the Invention

According to the configuration of one example of the present disclosure, a device and a method that enable safe driving by performing object recognition using image analysis and inter-vehicle communication information are implemented.

Specifically, for example, provided are an image analysis unit that analyzes an image captured by a vehicle-mounted camera and performs object recognition in the image, an unknown object identification unit that identifies an unknown object in an image area determined to be an unknown object area as a result of analysis by the image analysis unit, and a communication unit that transmits information to an unknown object such as a second vehicle identified by the unknown object identification unit. The unknown object identification unit identifies the second vehicle, which is an unknown object in the image area determined to be the unknown object area, using the peripheral object information received through the communication unit. The communication unit transmits unknown object information or control information for travel control of the second vehicle to the second vehicle.

With this configuration, a device and a method that enable safe driving by performing object recognition using image analysis and inter-vehicle communication information are implemented.

Note that the effect described in the present specification is merely an illustration and is not restrictive. Hence, additional effects can be obtained.

### BRIEF DESCRIPTION OF DRAWINGS

FIG. 1 is a diagram illustrating an outline of the configuration and processing of the present disclosure.

FIG. 2 is a diagram illustrating one example of the configuration and processing of a first example of the present disclosure.

FIG. 3 is a diagram illustrating semantic segmentation.

FIG. 4 is a diagram illustrating semantic segmentation and object recognition reliability score.

FIG. 5 is a diagram illustrating the configuration and processing of an unknown object area extraction unit.

FIG. 6 is a diagram illustrating the configuration and processing of an unknown object identification unit.

FIG. 7 is a diagram illustrating an example of communication data exchanged between vehicles.

FIG. 8 is a diagram illustrating an example of changing transmission data upon receipt of unknown object information.

FIG. 9 is a diagram illustrating a configuration example of an information processing device A mounted on a vehicle A.

FIG. 10 is a diagram illustrating a configuration example of an information processing device B mounted on a vehicle B.

FIG. 11 is a diagram showing a flowchart illustrating the processing sequence performed by the information processing device A mounted on the vehicle A.

FIG. 12 is a diagram showing a flowchart illustrating the processing sequence performed by the information processing device B mounted on the vehicle B.

FIG. 13 is a diagram illustrating the configuration and processing of a second example of the present disclosure.

FIG. 14 is a diagram illustrating a configuration example of an information processing device B of the second example of the present disclosure.

FIG. 15 is a diagram illustrating processing of a vehicle control unit of the information processing device B according to the second example of the present disclosure.

FIG. 16 is a diagram showing a flowchart illustrating the processing sequence performed by the information processing device B of the second example of the present disclosure.

FIG. 17 is a diagram illustrating the configuration and processing of a third example of the present disclosure.

FIG. 18 is a diagram showing a flowchart illustrating the processing sequence performed by an information processing device A of the third example of the present disclosure.

FIG. 19 is a diagram showing a flowchart illustrating the processing sequence performed by an information processing device B of the third example of the present disclosure.

FIG. 20 is a diagram illustrating the configuration and processing of a fourth example of the present disclosure.

FIG. 21 is a diagram illustrating processing performed by an unknown object information transmission necessity determination unit of a vehicle A of the fourth example of the present disclosure.

FIG. 22 is a diagram showing a flowchart illustrating the processing sequence performed by an information processing device A of the fourth example of the present disclosure.

FIG. 23 is a diagram illustrating the configuration and processing of a fifth example of the present disclosure.

FIG. 24 is a diagram illustrating the hardware configuration example of an information processing device.

### MODE FOR CARRYING OUT THE INVENTION

Hereinafter, details of an information processing device, an information processing system, and an information processing method of the present disclosure will be described with reference to the drawings. Note that the description will be given according to the following items.

1. Outline of configuration of present disclosure

2. One example (Example 1) of configuration and processing of information processing device mounted on vehicle

3. Configuration example of information processing device mounted on vehicle and sequence of processing performed by information processing device

4. Example (Example 2) of performing vehicle control on the basis of transmission of unknown object information.

5. Example (Example 3) of transmitting vehicle control information to unknown vehicle to perform remote control of other vehicle.

6. Example (Example 4) of determining necessity of information transmission to unknown vehicle and transmitting information only when transmission is necessary.

7. Example (Example 5) of performing processing using information acquired from multiple vehicles.

8. Configuration example of information processing device

9. Summary of configuration of present disclosure

### 1. Outline of Configuration of Present Disclosure

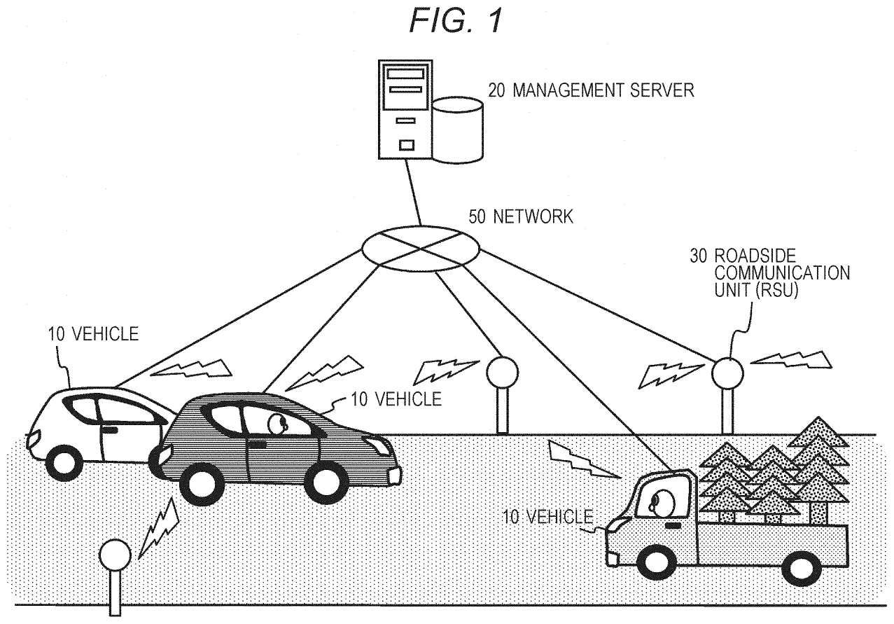

First, an outline of the configuration of the present disclosure will be described with reference to FIG. 1.

In the present disclosure, for example, a camera is mounted on a moving device such as a vehicle, and an object on the traveling path is recognized by analyzing an image captured by the camera. Moreover, in addition to this object recognition based on an image, communication is performed with another vehicle, another roadside communication unit (RSU: Roadside Unit), or a server, and object recognition is performed on the basis of these pieces of communication information. Through these processing, reliable object recognition is achieved, and safe driving of a moving device such as a vehicle is possible.

Note that while a moving device equipped with an information processing device that performs processing of the present disclosure will be described as a vehicle (automobile) in the following description, this is one example, and the processing of the present disclosure can also be used for various moving devices other than a vehicle such as moving devices like a traveling robot and a drone, for example.

Referring to FIG. 1, an outline of a configuration example and processing of the present disclosure will be described.

FIG. 1 shows multiple vehicles 10 traveling on a road. The vehicle 10 includes not only a conventional vehicle that travels by driving operation by the driver, but also an autonomous driving vehicle that does not require driving operation by the driver.

FIG. 1 shows the vehicle 10, a management server 20, and a roadside communication unit (RSU) 30. These components can communicate with each other through a network 50.

Communication between vehicles is called vehicle-to-vehicle communication (V2V communication). Additionally, communication between the vehicle and infrastructure equipment such as a roadside communication unit (RSU) is called vehicle-to-infrastructure communication (V2I communication). Additionally, these are collectively called V2X communication. V2X communication includes vehicle-to-vehicle, vehicle-to-infrastructure equipment, and vehicle-to-server communication, for example.

The vehicle 10 shown in FIG. 1 is a vehicle that performs the above V2X communication.

Each vehicle 10 transmits vehicle information such as own position information, vehicle type or vehicle size, and an identifier (ID) to other vehicles at any time or intermittently (multicast transmission).

Note that the own position information can be acquired by using position information acquired by using GPS or a dynamic map (DM) provided by the management server 20.

A dynamic map (DM) is a map that reflects successively changing traffic information such as traffic jam information and accident information, in addition to static map information. The management server 20 uses information received from vehicles and infrastructure equipment such as roadside communication units (RSUs) to generate and update a dynamic map that reflects the latest road conditions, and stores the map in a storage unit.

The dynamic map (DM) generated and updated by the management server 20 is provided to the vehicle 10, and the vehicle 10 can determine its own position, travel route, and the like on the basis of this map. An autonomous driving vehicle can select the optimum route and travel by referring to the dynamic map (DM).

Note that the vehicle 10 is equipped with a camera and, is configured to recognize an object such as an oncoming vehicle on a traveling path and perform control to avoid collision with the object.

Specifically, for example, in a case where the vehicle 10 is an autonomous driving vehicle, the vehicle 10 controls the traveling direction and controls stoppage and deceleration, for example, so as not to collide with the recognized object. Additionally, in a case of a vehicle driven by the driver, an object on the traveling path is displayed on a monitor that can be confirmed by the driver to warn the driver. For example, an object display area flashes or an alarm sound is given to alert the driver.

### 2. One Example (Example 1) of Configuration and Processing of Information Processing Device Mounted on Vehicle

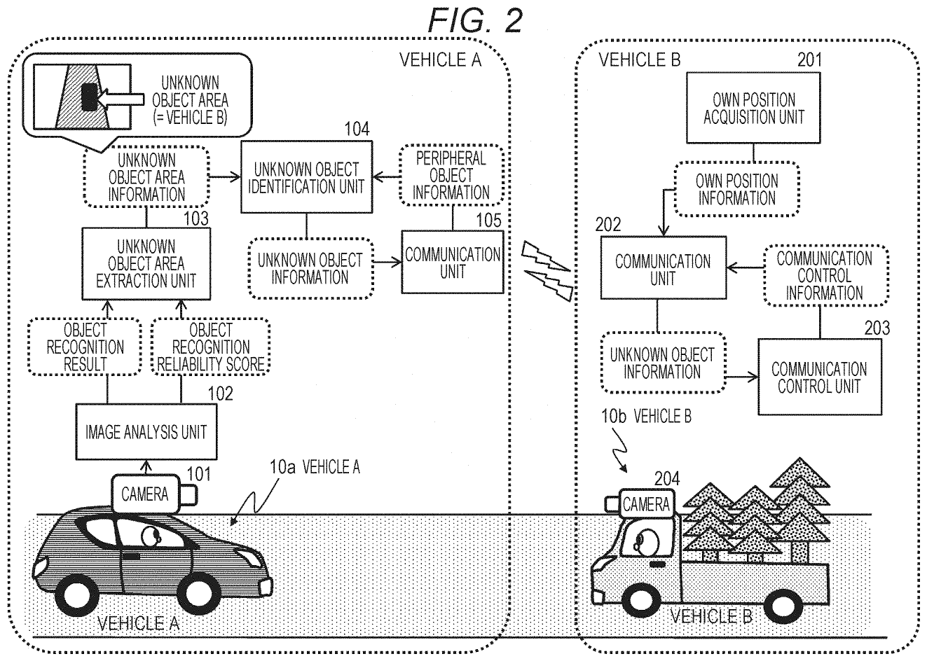

Next, one example (Example 1) of the configuration and processing of an information processing device mounted on a vehicle will be described with reference to FIG. 2 and following drawings.

FIG. 2 shows a configuration example of an information processing device mounted on a vehicle. Note that in the following, an example will be described of processing in which a vehicle A, 10a and a vehicle B, 10b communicate with each other using vehicle-to-vehicle communication (V2V communication) in a situation where the vehicle A, 10a on the left side in FIG. 2 is traveling and approaching the vehicle B, 10b on the right side in FIG. 2.

The block diagram shown in FIG. 2 is configurations used to perform the above processing. These configurations correspond to some of configurations of the information processing device mounted on each vehicle.

First, the configuration of the information processing device mounted on the vehicle A, 10a will be described.

The Vehicle A, 10a has a camera 101 and captures an image in the traveling direction, for example. The captured image is input to an image analysis unit 102.

The image analysis unit 102 analyzes the image captured by the camera 101 to perform recognition processing of an object in the image. That is, object recognition is performed to recognize what the object captured in each image area of the captured image is.

The object recognition processing performed by the image analysis unit 102 is performed by applying an existing method such as pattern matching or semantic segmentation, for example.

For example, pattern matching is processing for storing pattern data including the shape and feature information of a person or a car in a storage unit, and comparing the pattern data stored in the storage unit with a subject in an image area in a captured image to recognize each subject.

Semantic segmentation is a technology for storing dictionary data (learned data) for object recognition based on the shape and other feature information of various actual objects in a storage unit, and recognizing what an object in an image is on the basis of the degree of match between this dictionary data and the object in the captured image. Note, however, that semantic segmentation uses more detailed learning data to perform object recognition on a pixel-by-pixel basis in a captured image.

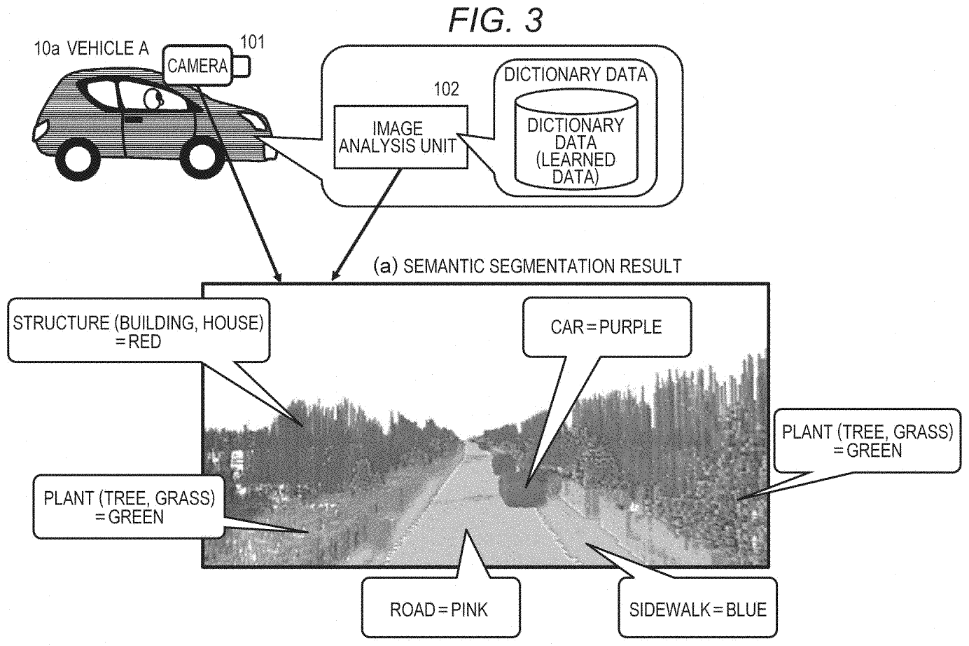

Referring to FIG. 3 and following drawings, an outline of semantic segmentation will be described. FIG. 3 shows one example of the result of semantic segmentation performed on an image taken by the camera 101 provided in the vehicle 10a. Note that although the image shown in FIG. 3 is a black-and-white image, it is actually a color image.

The image analysis unit 102 refers to the dictionary data (learned data) for object recognition based on the shape and other feature information of various actual objects, and performs object recognition on a pixel-by-pixel basis in the captured image.

The image analysis unit 102 performs object recognition for recognizing what an object in the image is on the basis of the degree of match between the dictionary data and the object in the image. As a result, an image color-coded according to the type of object shown in FIG. 3 is generated.

The image shown in FIG. 3 is color-coded according to the following object types.

Structure (building, house)=red

Car=purple

Plant (tree, grass)=green

Road=pink

Sidewalk=blue

These are the result of color coding according to the type of object recognized on the basis of the dictionary data.

For example, an autonomous driving vehicle can perform safe driving by using such an object recognition result and performing driving control to avoid an object in the traveling direction with which the vehicle may collide.

As described above, the image analysis unit 102 performs object recognition processing using existing technologies such as semantic segmentation or pattern matching.

Moreover, the image analysis unit 102 generates a reliability score indicating the reliability of the object recognition result together with the object recognition result.

The reliability score is a score indicating the reliability of the object recognition for each recognized object recognized in the captured image.

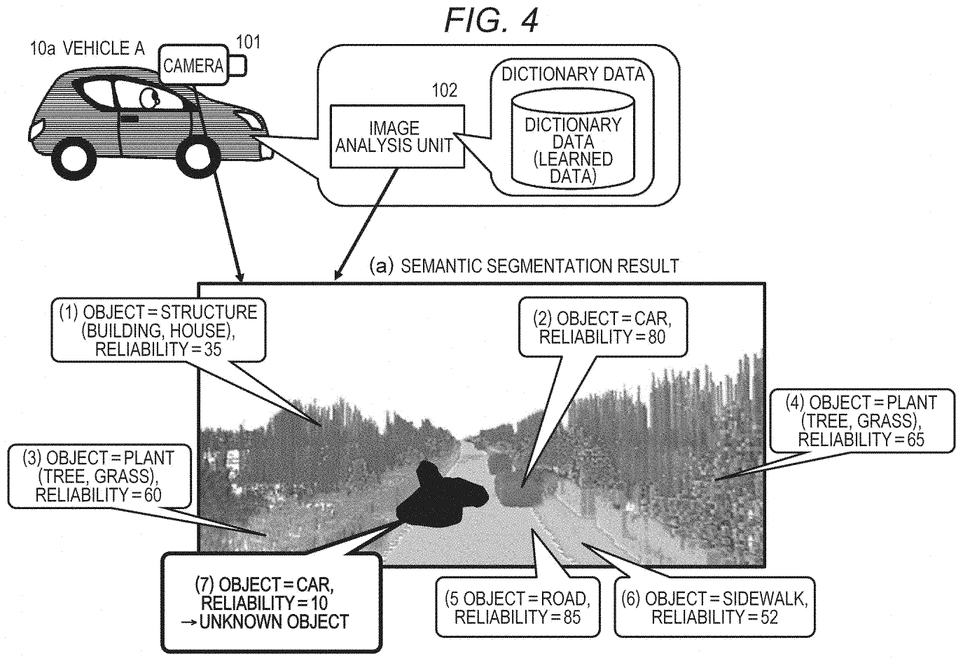

FIG. 4 shows an example of data in which the recognition reliability is associated with each of object recognition results, which are the results of semantic segmentation processing.

The example shown in FIG. 4 is an example in which a reliability score of 0 to 100 is set with a minimum reliability of 0 and a maximum reliability of 100.

In the example shown in FIG. 4, the following reliability scores are set corresponding to the recognized objects.

(1) Recognition result=structure (building, house), reliability score=35,

(2) Recognition result=car, reliability score=80,

(3) Recognition result=plant (tree, grass), reliability score=60,

(4) Recognition result=plant (tree, grass), reliability score=65,

(5) Recognition result=road, reliability score=85,

(6) Recognition result=sidewalk, reliability score=52,

(7) Recognition result=car, reliability score=10→unknown object

If the reliability score is high, it can be determined that the recognition result is correct, but if the recognition result is low, the recognition result may be unreliable.

For Example

(7) Recognition result=car, reliability score=10

The reliability score of this recognition result is 10, and an object with such extremely low reliability is determined to be an unknown object.

Note that specifically, a reliability threshold value such as a threshold value=20, is set, and an object having a reliability score equal to or lower than this threshold value, or reliability score lower than this threshold value is determined to be an “unknown object”.

Note that while FIG. 4 shows an application example of semantic segmentation, the image analysis unit 102 may use not only semantic segmentation, but also various other methods such as pattern matching to perform object recognition on an image captured by a camera. Note, however, that even when other methods are applied, the object recognition result and the reliability score corresponding to each recognition result are generated together.

As shown in FIG. 2, the object recognition result and the object recognition reliability score generated by the image analysis unit 102 are input to an unknown object area extraction unit 103.

The unknown object area extraction unit 103 extracts an unknown object area from the image captured by the camera 101 by using the “object recognition result” and the “object recognition reliability score” input from the image analysis unit 102.

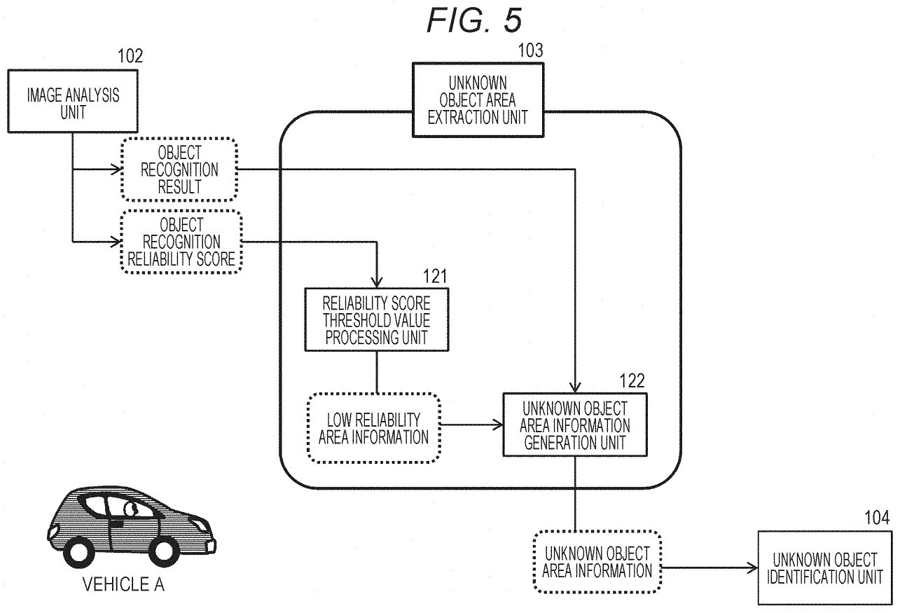

The detailed configuration and detailed processing of the unknown object area extraction unit 103 will be described with reference to FIG. 5.

As shown in FIG. 5, the unknown object area extraction unit 103 receives the “object recognition result” and the “object recognition reliability score” from the image analysis unit 102.

The object recognition reliability score is input to a reliability score threshold value processing unit 121 of the unknown object area extraction unit 103.

The reliability score threshold value processing unit 121 compares a threshold value defined in advance by the “object recognition reliability score”, such as “threshold value=20”, with the reliability score set corresponding to each recognized object, generates “low reliability area information” in which a reliability equal to or lower than the threshold value is set, and outputs the low reliability area information to an unknown object area information generation unit 122.

The unknown object area information generation unit 122 receives the “object recognition result” from the image analysis unit 102, and receives the “low reliability area information” indicating the image area in which a reliability equal to or lower than the threshold value is set from the reliability score threshold value processing unit 121.

The unknown object area information generation unit 122 determines that, in the “object recognition result” received from the image analysis unit 102, an object corresponding to the low reliability area in which the reliability equal to or lower than the threshold value is set is an unknown object, generates “unknown object area information” indicating the image area occupied by the unknown object, and outputs the unknown object area information to an unknown object identification unit 104.

The unknown object identification unit 104 receives the “unknown object area information” generated by the unknown object area information generation unit 122, and performs processing for identifying the unknown object such as identifying the area indicated by the “unknown object area information”, that is, identifying the position of the unknown object in the image area in which the object recognition reliability score is equal to or lower than the threshold value, for example.

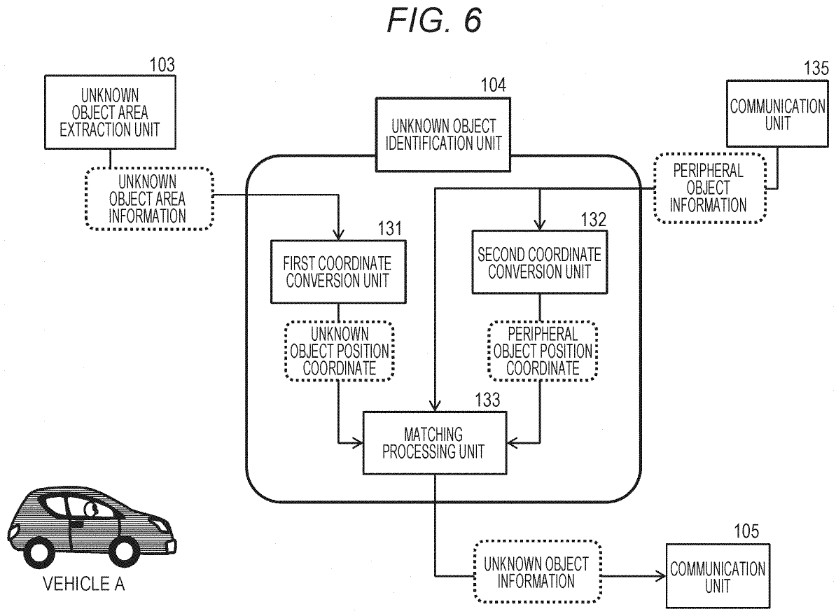

The detailed configuration and processing of the unknown object identification unit 104 will be described with reference to FIG. 6.

As shown in FIG. 6, the “unknown object area information” generated by the unknown object area information generation unit 122 is input to the unknown object identification unit 104. The “unknown object area information” is input to a first coordinate conversion unit 131 of the unknown object identification unit 104.

The unknown object identification unit 104 further acquires “peripheral object information” including position information of various objects including objects currently surrounding the vehicle, such as other vehicles, through a communication unit 105, and inputs the “peripheral object information” to a second coordinate conversion unit 135.

The communication unit 105 performs vehicle-to-vehicle communication (V2V communication) with vehicles currently surrounding the vehicle, and receives vehicle information (vehicle position, vehicle ID, vehicle type, vehicle size, V2V communication address, and the like) including the position information of each vehicle from the surrounding vehicles. Moreover, the communication unit 105 also performs communication with the management server 20 and the roadside communication unit (RSU) 30 described with reference to FIG. 1, and acquires, from these units, information that can confirm the surrounding conditions including the dynamic map (DM), specifically, position information (three-dimensional position information) of various objects.

As shown in FIG. 6, the unknown object identification unit 104 inputs the “unknown object area information” generated by the unknown object area information generation unit 122 into the first coordinate conversion unit 131, and inputs the “peripheral object information” acquired through the communication unit 105 into the second coordinate conversion unit 135.

The “unknown object area information” generated by the unknown object area information generation unit 122 and the peripheral object position information included in the “peripheral object information” acquired through the communication unit 105 are position information corresponding to their own coordinates, and these two pieces of position information cannot be matched directly.

The first coordinate conversion unit 131 and the second coordinate conversion unit 132 convert of these pieces of position information into coordinate position information having one common coordinate.

Thereafter, the peripheral object position information included in the “unknown object area information” and the “peripheral object information” converted into the common coordinate position information is input to a matching processing unit 133.

The matching processing unit detects a matching area between the “unknown object area information” and the “peripheral object position information”.

For example, the matching processing unit 133 detects a specific vehicle position determined to be an unknown object in image analysis.

The matching processing unit 133 detects a specific vehicle position determined to be an unknown object by these processing, and further, acquires information regarding the vehicle corresponding to the detected position information by referring to the “peripheral object information” received through the communication unit.

The matching processing unit 133 identifies the vehicle determined to be an unknown object by image analysis, on the basis of the “peripheral object information” received through the communication unit.

The unknown object identification unit 104 further transmits “unknown object information” to the vehicle identified by the matching processing unit 133 through the communication unit 105 using vehicle-to-vehicle communication (V2V communication).

Note that the “peripheral object information” received by the unknown object identification unit 104 through the communication unit 105 includes address information of each vehicle that can be used for communication (unicast communication) with each vehicle, as described above. That is, vehicle information (vehicle position, vehicle ID, vehicle type, vehicle size, V2V communication address, and the like) including the position information of each vehicle is received from surrounding vehicles by vehicle-to-vehicle communication (V2V communication) with the vehicles. By using this address information, “unknown object information” can be transmitted to another vehicle which is the identified object.

As described above, the vehicle A, 10a shown in FIG. 2 transmits the “unknown object information” through the communication unit 105 to the vehicle B, 10b shown in FIG. 2 which is determined to be an unknown object in the image analysis by the vehicle A, 10a.

Next, referring to FIG. 2, the configuration and processing of an information processing device mounted on the vehicle B, 10b shown in FIG. 2 will be described.

A communication unit 202 of the vehicle B, 10b receives “unknown object information” from the vehicle A, 10a.

By this reception processing, the vehicle B, 10b can confirm that the vehicle is recognized as an unknown object by surrounding vehicles.

The “unknown object information” received by the communication unit 202 of the vehicle B, 10b from the vehicle A, 10a is input to a communication control unit 203.

The communication control unit 203 controls the communication of the communication unit 202, and performs processing of changing the transmission mode of the vehicle information being transmitted (multicast transmission) through the communication unit 202.

Note that the vehicle information being transmitted (multicast transmission) through the communication unit 202 is vehicle information (vehicle position, vehicle ID, vehicle type, vehicle size, V2V communication address, and the like) including the own position information of the vehicle acquired by an own position acquisition unit 201 such as GPS of the vehicle B, 10b. These pieces of vehicle information are constantly or intermittently multicast-transmitted through the communication unit 202.

The communication control unit 203 controls the communication of the communication unit 202, and changes the transmission mode of these pieces of vehicle information being transmitted through the communication unit 202. Specifically, communication control such as communication band, communication frequency, increase in communication output, and selection processing according to the priority of transmission data is performed.

This communication control enables the surrounding vehicles of the vehicle B, 10b to reliably receive important vehicle information with high priority, such as vehicle position information and vehicle type, which are multicast-transmitted from the vehicle B, 10b, and to correctly grasp the actual conditions of the vehicle B, 10b.

As a result, the vehicle A, 10a, too, can accurately grasp the position, vehicle type, and the like of the object determined to be unknown by the image analysis, that is, the vehicle B, 10b.

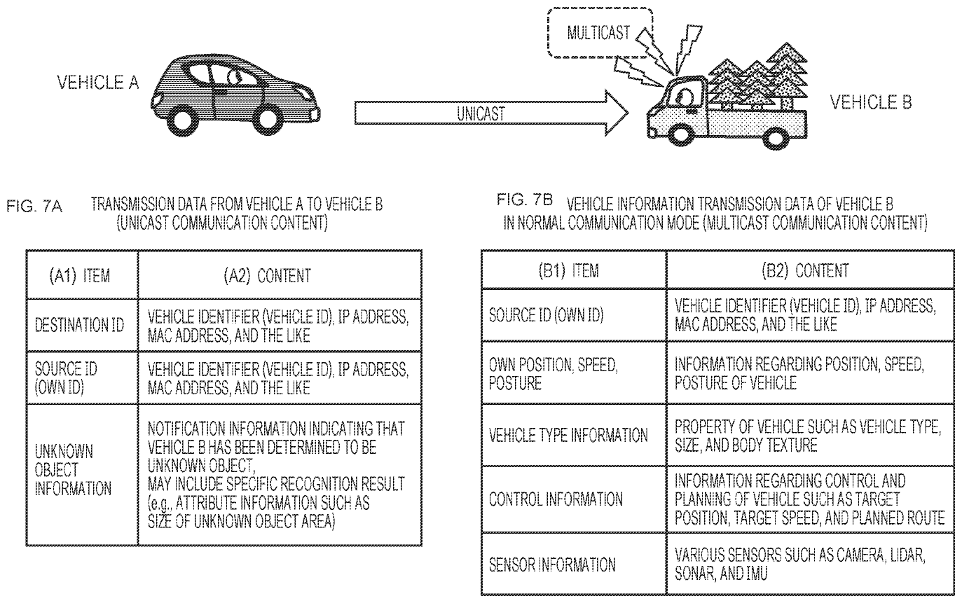

Specific examples of the content of the communication data of “unknown object information” transmitted (unicast transmission) by the vehicle A, 10a to the vehicle B, 10b, and the vehicle information multicast-transmitted by the vehicle B, 10b will be described with reference to FIG. 7.

FIG. 7 shows communication data of

(A) transmission data from vehicle A to vehicle B (content of data transmitted by unicast communication), and

(B) vehicle information transmission data of vehicle B in normal communication mode (content of data transmitted by multicast communication).

First, (B) vehicle information transmission data of vehicle B in normal communication mode (content of data transmitted by multicast communication) will be described.

This data is data that each vehicle transmits by multicasting constantly or intermittently, and is data that can be received by surrounding vehicles.

This multicast transmission data includes the following data, for example.

Source ID (own ID)=address information for communication such as vehicle identifier (vehicle ID), IP address, and MAC address.

Own position, speed, posture=information regarding the position, speed, and posture of the vehicle.

Vehicle type information=property information of the vehicle such as vehicle type, size, and body texture.

Control information=information regarding control and planning of the vehicle, such as target position, target speed, and planned route.

Sensor information=acquired information from various sensors such as a camera, a LIDAR (laser-type range sensor), a sonar, and an inertial measurement unit (IMU).

Note that these pieces of transmission data are examples, and it is not essential to include all of them.

For example, the target position, the target speed, the planned route, and the like included in the control information, the information regarding the control and planning of the vehicle, for example, are information set mainly at the start of traveling in an autonomous driving vehicle, and this information may not necessarily be transmitted in the case of a vehicle other than the autonomous driving vehicle, for example.

Additionally, as for the sensor information, since the mounted sensor is different for each vehicle, the transmission data is different for each vehicle.

These pieces of multicast transmission data can be received by surrounding vehicles, and the surrounding vehicles can accurately grasp the actual condition of vehicle B by analyzing these pieces of multicast transmission data.

Additionally, by acquiring an IP address or the like, it becomes possible to perform direct communication (unicast communication) with the vehicle B.

Next, (A) transmission data from vehicle A to vehicle B (content of data transmitted by unicast communication) will be described.

This data (A) is data to be transmitted when the vehicle A detects that the area determined to be an unknown object by image analysis is the vehicle B and notifies the vehicle B that the vehicle B has been recognized as an “unknown object”.

This data (A) includes the following data, for example.

Destination ID (unicast communication data destination ID)=communication partner's vehicle identifier (vehicle ID), IP address, MAC address

Source ID (own ID)=vehicle identifier (vehicle ID), IP address, MAC address

Unknown object information=notification information indicating that the communication partner has been determined to be an unknown object

Note that the unknown object information may include information analyzed in the image analysis. For example, size information or the like of an unknown object area may be included.

The vehicle B that receives this data (A) can know that the vehicle A, which is a surrounding vehicle, has determined that the own vehicle is an unknown object.

The “unknown object information” received by the communication unit 202 of the vehicle B, 10b from the vehicle A, 10a is input to the communication control unit 203, and the communication control unit 203 controls the communication of the communication unit 202 to perform processing of changing the transmission mode of the vehicle information being multicast-transmitted through the communication unit 202.

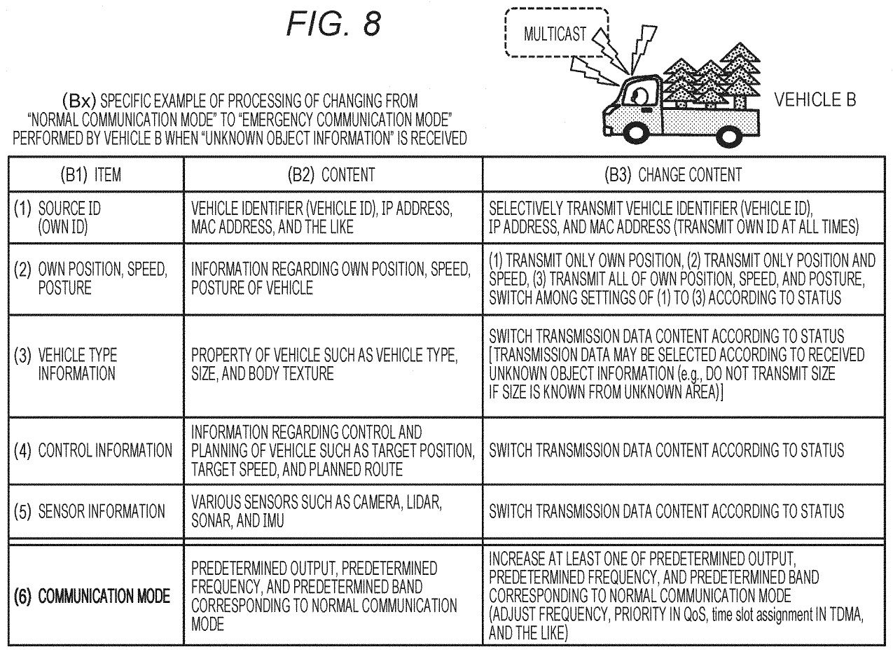

Referring to FIG. 8, an example of the processing of changing the transmission mode of transmission data performed by the communication control unit 203 of the vehicle B, 10b will be described.

FIG. 8 is a diagram showing an example of changing the transmission mode of transmission data performed by the communication control unit 203 when the vehicle B, 10b receives “unknown object information” from a surrounding vehicle.

FIG. 8 shows the (B1) item and (B2) content of the multicast transmission data of the vehicle information similar to those of FIG. 7(B), and further, as (B3), an example of change made when “unknown object information” is received.

Note that in the table of FIG. 8, an example of changing the communication mode is also shown at the bottom.

As described above with reference to FIG. 7(B), the multicast transmission data includes the following data, for example.

Source ID (own ID)=address information for communication such as vehicle identifier (vehicle ID), IP address, and MAC address.

Own position, speed, posture=information regarding the position, speed, and posture of the vehicle.

Vehicle type information=property information of the vehicle such as vehicle type, size, and body texture.

Control information=information regarding control and planning of the vehicle, such as target position, target speed, and planned route.

Sensor information=acquired information from various sensors such as a camera, a LIDAR (laser-type range sensor), a sonar, and an inertial measurement unit (IMU).

When the vehicle B, 10b receives “unknown object information” from a surrounding vehicle such as the vehicle A, 10a, the communication control unit 203 performs processing to switch to transmission in an emergency communication mode for the multicast transmission data being transmitted in the normal communication mode through the communication unit 202.

For example, the following transmission data change processing is performed in units of transmission data (1) to (5) shown in FIG. 8.

(1) Source ID (own ID)=vehicle identifier (vehicle ID), IP address, MAC address

In a case where “unknown object information” is received from a surrounding vehicle, the communication control unit 203 selectively transmits a vehicle identifier (vehicle ID), an IP address, or a MAC address according to the situation. Note, however, that the vehicle identifier (vehicle ID) is transmitted at all times.

Specifically processing is performed to transmit two pieces of data which are the vehicle identifier (vehicle ID) and the IP address, for example. By performing such limited transmission processing, it is possible to reduce the communication data and increase the probability that the data can be reliably transmitted to the destination.

Note that the transmission priority is set in advance for each data, and the communication control unit 203 selects and transmits the transmission data in descending order of transmission priority.

Additionally, the communication control unit 203 acquires the available communication band information at the time of data transmission, for example, and performs processing such that if the available band is sufficient, all of the vehicle identifier (vehicle ID), IP address, and MAC address are transmitted, and if the available band is not sufficient, only the information selected from thereamong is transmitted.

(2) Own position, speed, posture=information regarding the position, speed, and posture of the vehicle,

regarding the own position, speed, and posture, similar to (1) above, the communication control unit 203 performs selective transmission processing according to the status of the available communication band or the like and the transmission priority set in association with each data. Specifically, for example, in a case where the available communication band is small, processing is performed to transmit only the own position. By performing such limited transmission processing, it is possible to increase the probability of reliably notifying the destination of the own position information.

(3) Vehicle type information=property information of the vehicle such as vehicle type, size, and body texture,

(4) control information=information regarding control and planning of the vehicle such as target position, target speed, and planned route,
(5) sensor information=acquired information from various sensors such as a camera, a LIDAR (laser-type range sensor), a sonar, and an inertial measurement unit (IMU),

for each of these pieces of information, similar to (1) and (2) above, the communication control unit 203 performs selective transmission processing according to the status of the available communication band or the like and the transmission priority set in association with each data. Specifically, for example, in a case where the available communication band is small, processing is performed to transmit only the vehicle type and size. By performing such limited transmission processing, it is possible to increase the probability of reliably notifying the destination of the vehicle type and size.

(6) The communication mode change processing is as follows.

In the normal communication mode, multicast transmission using a predetermined output, frequency, and band is performed.

Upon receipt of the “unknown object information” from the surrounding vehicle, the communication control unit 203 changes the normal communication mode to the emergency communication mode, performs selective transmission according to the priority of the transmission data described above, and also changes the communication mode. Specifically, for example, multicast transmission is performed by performing control to increase at least one of output, frequency, or band.

For example, communication control for increasing the reception probability of transmission data is performed by controlling the communication frequency, controlling the priority in QoS, controlling the time slot assignment processing, and the like.

By performing such processing, it is possible to reliably notify the surrounding vehicles of important vehicle information having a high priority regarding the vehicle.

### [3. Configuration Example of Information Processing Device Mounted on Vehicle and Sequence of Processing Performed by Information Processing Device]

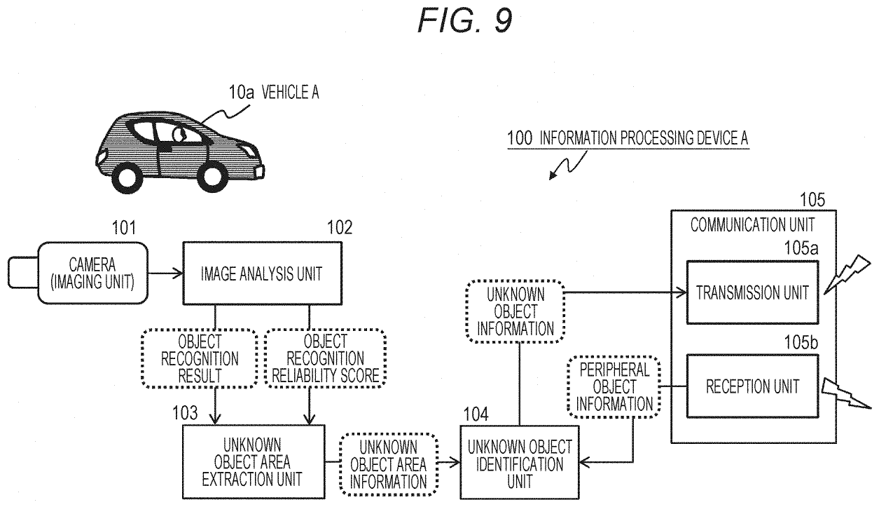

Next, referring to FIG. 9 and following drawings, a configuration example of the information processing device mounted on the vehicle in Example 1 and a sequence of processing performed by the information processing device will be described.

FIG. 9 is a block diagram showing a configuration example of an information processing device A, 100 mounted on the vehicle A, 10a.

This configuration diagram has a similar configuration as the configuration of the information processing device of the vehicle A, 10a described above with reference to FIG. 2.

The information processing device A, 100 includes a camera (imaging unit) 101, an image analysis unit 102, an unknown object area extraction unit 103, an unknown object identification unit 104, and a communication unit 105.

The communication unit 105 includes a transmission unit 105a that performs unicast transmission and the like, for example, and a reception unit 105b that performs reception processing of multicast communication data, for example.

The camera (imaging unit) 101 captures an image of the vehicle in the traveling direction, for example.

The image analysis unit 102 receives the image captured by the camera (imaging unit) 101, and performs recognition processing of objects included in the captured image. For example, as described above, object recognition is performed using existing technologies such as pattern matching and semantic segmentation.

The image analysis unit 102 generates pair data of “object recognition result” which is the result of the object recognition processing and “object reliability score” indicating the reliability of the object recognition, for each recognition result, and outputs the pair data to the unknown object area extraction unit 103.

The unknown object area extraction unit 103 receives the “object recognition result” and the “object reliability score” from the image analysis unit 102, extracts an area where the “object reliability score” is equal to or lower than a predetermined threshold value, and outputs this extracted area to the unknown object identification unit 104 as “unknown object area information”.

The unknown object identification unit 104 receives the “unknown object area information” from the unknown object area extraction unit 103, and further receives “peripheral object information” through the reception unit 105b of the communication unit 105. The “peripheral object information” received through the reception unit 105b includes data received from other vehicles by vehicle-to-vehicle communication (V2V), as well as data received from the roadside communication unit (RSU) 30 and management server 20 shown in FIG. 1.

The unknown object identification unit 104 uses each of these pieces of data to perform the processing described above with reference to FIG. 6, identifies the coordinate position indicated by the “unknown object area information”, and identifies an object, such as another vehicle, that is in the identified coordinate position. This identified information is generated as “unknown object information”, and the “unknown object information” is transmitted through the transmission unit 105a of the communication unit 105.

Note that the “peripheral object information” received through the reception unit 105b of the communication unit 105 includes address information of each vehicle that can be used for communication (unicast communication) with each vehicle, and this address information is used to transmit the “unknown object information” to the identified vehicle which is an identified object.

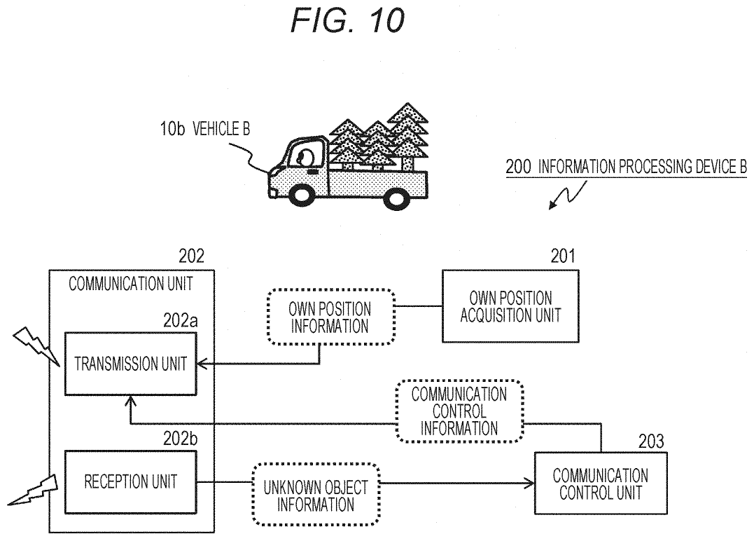

Next, referring to FIG. 10, the configuration and processing of an information processing device B, 200 mounted on the vehicle B, 10b will be described.

The configuration diagram shown in FIG. 10 has a similar configuration as the configuration of the information processing device of the vehicle B, 10b described above with reference to FIG. 2.

The information processing device B, 200 includes an own position acquisition unit 201, a communication unit 202, and a communication control unit 203. The communication unit 202 includes a transmission unit 202a that performs multicast transmission and the like, for example, and a reception unit 202b that performs reception processing of unicast communication data, for example.

The own position acquisition unit 201 acquires the own position by using GPS, a dynamic map provided by the management server 20, or the like. The acquired own position information is multicast-transmitted together with other vehicle information through the transmission unit 202a of the communication unit 202.

The vehicle information transmitted by multicast is the data described above with reference to FIG. 7(B), for example.

The reception unit 202b of the communication unit 202 receives, for example, “unknown object information” unicast-transmitted by another surrounding vehicle.

The “unknown object information” received by the reception unit 202b of the communication unit 202 is input to the communication control unit 203.

Upon detection of the input of the “unknown object information”, the communication control unit 203 controls the communication unit 202 to change the transmission data content of the vehicle information which is the multicast transmission data or change the transmission mode, for example.

This processing is the processing described above with reference to FIG. 8.

That is, communication control is performed so that the multicast transmission data transmitted by the vehicle B, 10b can be reliably received by surrounding vehicles.

Specifically, for example, transmission data restriction processing, that is, transmission processing of only data selected according to priority, communication mode change processing for increasing transmission output, band, and transmission frequency, and the like are performed.

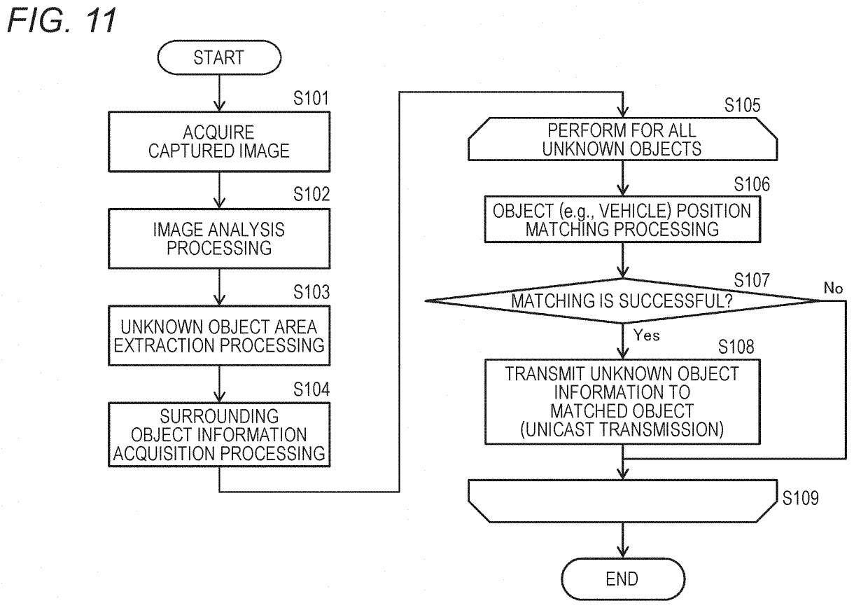

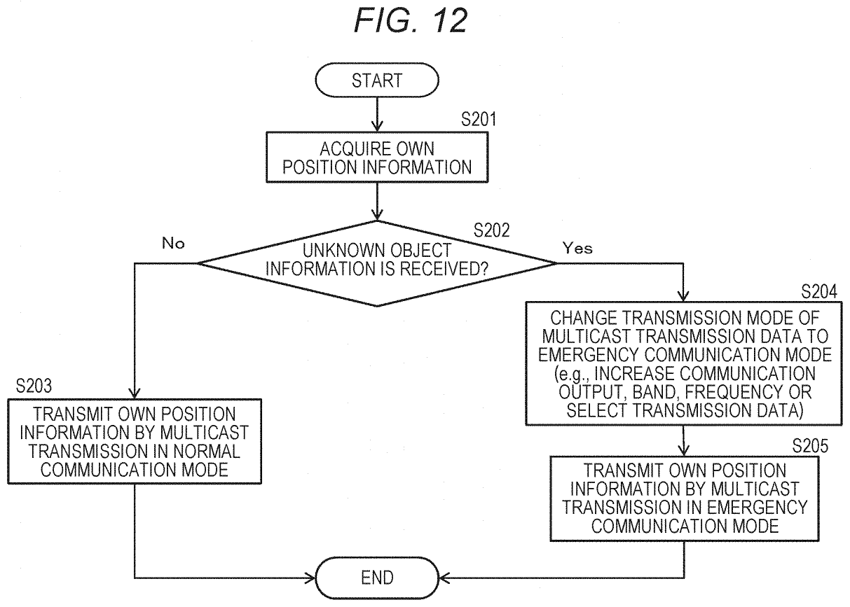

Next, referring to the flowcharts shown in FIGS. 11 and 12, the processing sequence performed by the information processing devices described with reference to FIGS. 9 and 10 will be described.

The flowchart shown in FIG. 11 is a flowchart illustrating the processing sequence performed by the information processing device A, 100 shown in FIG. 9, that is, the information processing device A, 100 mounted on the vehicle A, 10a.

Additionally, the flowchart shown in FIG. 12 is a flowchart illustrating the processing sequence performed by the information processing device B, 200 shown in FIG. 10, that is, the information processing device B, 200 mounted on the vehicle B, 10b.

The processing according to the flowcharts shown in FIGS. 11 and 12 can be performed according to a program stored in a storage unit of the information processing device, for example.

First, referring to the flowchart shown in FIG. 11, the processing sequence performed by the information processing device A, 100 shown in FIG. 9, that is, the information processing device A, 100 mounted on the vehicle A, 10a will be described.

Hereinafter, the processing of each step of the flowchart will be described.

(Step S101)

First, the information processing device A, 100 acquires a captured image.

This processing is processing performed by the camera (imaging unit) 101 of the information processing device A, 100 shown in FIG. 9, The camera (imaging unit) 101 captures an image of the vehicle in the traveling direction, for example.

The image captured by the camera (imaging unit) 101 is input to the image analysis unit 102.

(Step S102)

Next, in step S102, image analysis processing of the image captured by the camera (imaging unit) 101 is performed.

This processing is processing performed by the image analysis unit 102.

The image analysis unit 102 receives the image captured by the camera (imaging unit) 101, and performs recognition processing of objects included in the captured image. For example, as described above, object recognition is performed using existing technologies such as pattern matching and semantic segmentation.

The image analysis unit 102 generates pair data of “object recognition result” which is the result of the object recognition processing and “object reliability score” indicating the reliability of the object recognition, for each recognition result, and outputs the pair data to the unknown object area extraction unit 103.

(Step S103)

Next, in step S103, an unknown object area is extracted from the image captured by the camera (imaging unit) 101.

This processing is performed by the unknown object area extraction unit 103.

The unknown object area extraction unit 103 receives the “object recognition result” and the “object reliability score” from the image analysis unit 102, extracts an area where the “object reliability score” is equal to or lower than a predetermined threshold value, and outputs this extracted area to the unknown object identification unit 104 as “unknown object area information”.

(Step S104)

Next, in step S104, surrounding object information acquisition processing is performed.

This processing is executed by the unknown object identification unit 104.

The unknown object identification unit 104 receives the “unknown object area information” from the unknown object area extraction unit 103, and further receives “peripheral object information” through the reception unit 105b of the communication unit 105. Note that the “peripheral object information” includes data received from other vehicles by vehicle-to-vehicle communication (V2V), as well as data received from the roadside communication unit (RSU) 30 and management server 20 shown in FIG. 1.

(Steps S105 to S109)

Next, the unknown object identification unit 104 performs processing of steps S105 to S109 sequentially or in parallel for all the unknown object areas extracted in step S103.

First, in step S106, matching processing is performed between the unknown object area extracted in step S103 and the position information of the peripheral object acquired in step S104.

That is, a peripheral object such as a vehicle that matches the unknown object area is detected.

In step S107, it is determined whether or not the matching is successful, that is, whether or not a peripheral object that matches the unknown object area can be detected.

If the matching is successful, that is, if a peripheral object that matches the unknown object area can be detected, the processing proceeds to step S108.

On the other hand, if the matching fails, that is, if a peripheral object that matches the unknown object area cannot be detected, the processing proceeds to step S109, and the processing for this unknown object area ends.

If the matching is successful, that is, if a peripheral object that matches the unknown object area can be detected, the processing proceeds to step S108, and in step S108, the peripheral object that matches the unknown object area is identified, and “unknown object information” is transmitted to the identified object such as an identified vehicle.

The transmission of “unknown object information” to the identified vehicle is performed as a unicast transmission to the identified vehicle by using the address information included in the multicast transmission data received from the identified vehicle.

As explained above with reference to FIG. 7(A), this data transmitted by unicast transmission includes a destination ID, a source ID (own ID), and unknown object information, that is, notification information indicating that the identified vehicle has been determined to be an unknown object.

The information processing device A, 100 of the vehicle A performs the processing of steps S105 to S109 sequentially or in parallel for all the unknown object areas extracted in step S103.

Next, referring to the flowchart shown in FIG. 12, the processing sequence performed by the information processing device B, 200 shown in FIG. 10, that is, the information processing device B, 200 mounted on the vehicles B, 10b will be described.

(Step S201)

First, the information processing device B, 200 acquires the own position information in step S201.

This processing is processing performed by the own position acquisition unit 20 shown in FIG. 10.

The own position acquisition unit 201 acquires the own position by using GPS, a dynamic map provided by the management server 20, or the like.

(Step S202)

Next, in step S202, it is determined whether or not “unknown object information” has been received.

For example, the “unknown object information” is “unknown object information” transmitted in step S108 described with reference to the flowchart shown in FIG. 11.

If it is determined in step S202 that “unknown object information” has not been received, the processing proceeds to step S203.

On the other hand, if it is determined in step S202 that “unknown object information” has been received, the processing proceeds to step S204.

(Step S203)

If it is determined in step S202 that “unknown object information” has not been received, the processing proceeds to step S203, and in step S203, the own position information acquired in step S201 is multicast-transmitted in the normal communication mode.

This multicast transmission data is the data described above with reference to FIG. 7(B), and includes the following data, for example.

Source ID (own ID)=address information for communication such as vehicle identifier (vehicle ID), IP address, and MAC address.

Own position, speed, posture=information regarding the position, speed, and posture of the vehicle.

Vehicle type information=property information of the vehicle such as vehicle type, size, and body texture.

Control information=information regarding control and planning of the vehicle, such as target position, target speed, and planned route.

Sensor information=acquired information from various sensors such as a camera, a LIDAR (laser-type range sensor), a sonar, and an inertial measurement unit (IMU).

(Step S204) On the other hand, if it is determined in step S202 that “unknown object information” has been received, the processing proceeds to step S204.

In step S204, the transmission mode of the multicast transmission data is changed to the emergency communication mode. Specifically, communication control such as selection processing according to the priority of transmission data and changing of communication frequency, output, and band is performed.

This processing is the processing of changing the transmission mode of the transmission data described above with reference to FIG. 8, and is performed by the communication control unit 203 shown in FIG. 10.

Note that in the normal communication mode, predetermined data such as the data shown in FIG. 7(B) is transmitted by multicast transmission using a predetermined output, frequency, and band.

In the emergency communication mode, as described with reference to FIG. 8, communication control is performed to selectively transmit important data selected according to transmission priority information preset for each transmission data, to change output, frequency, band change, and priority control in QoS, and to perform time slot assignment processing, for example. These communication control make it possible to increase the probability that surrounding vehicles can receive important vehicle information.

### 4. Example (Example 2) of Performing Vehicle Control on the Basis of Transmission of Unknown Object Information

Next, as Example 2, an example in which vehicle control is performed on the basis of transmission of unknown object information will be described.

In the example described above, in a case where the vehicle A, 10a determines that the vehicle B, 10b is an unknown object in the image analysis, the vehicle A, 10a transmits “unknown object information” to the vehicle B, 10b, and upon receipt of the “unknown object information”, the vehicle B, 10b performs processing of changing the content and transmission mode of transmission data of vehicle information being multicast-transmitted.

Example 2 described below is the same in that in a case where a vehicle A, 10a determines that a vehicle B, 10b is an unknown object in the image analysis, the vehicle A, 10a transmits “unknown object information” to the vehicle B, 10b. In Example 2, upon receipt of “unknown object information”, the vehicle B, 10b performs travel control of the vehicle B, 10b.

Specifically, for example, travel control for collision avoidance such as reduction of traveling speed or stop processing is performed.

Hereinafter, this Example 2 will be described.

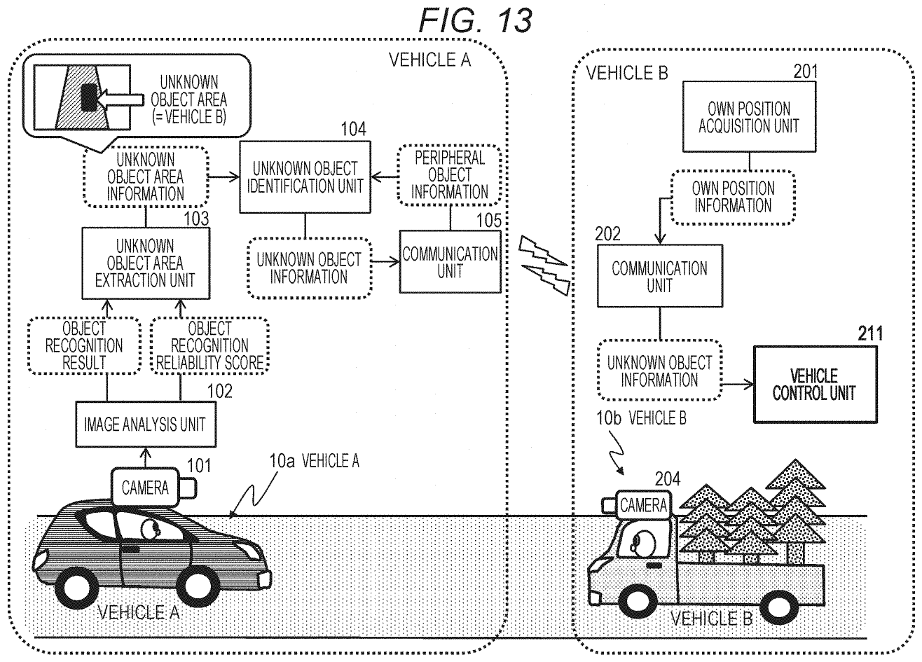

FIG. 13 is a diagram showing a configuration example of an information processing device mounted on a vehicle of Example 2. Similar to the example described above, an example will be described of processing in which the vehicle A, 10a and the vehicle B, 10b communicate with each other using vehicle-to-vehicle communication (V2V communication) in a situation where the vehicle A, 10a on the left side in FIG. 13 is traveling and approaching the vehicle B, 10b on the right side in FIG. 13.

In Example 2, the information processing device mounted on the vehicle A, 10a has a similar configuration as that described above with reference to FIG. 2.

In Example 2, the configuration of the information processing device mounted on the vehicle B, 10b is different.

As shown in FIG. 13, the vehicle B, 10b has a vehicle control unit 211.

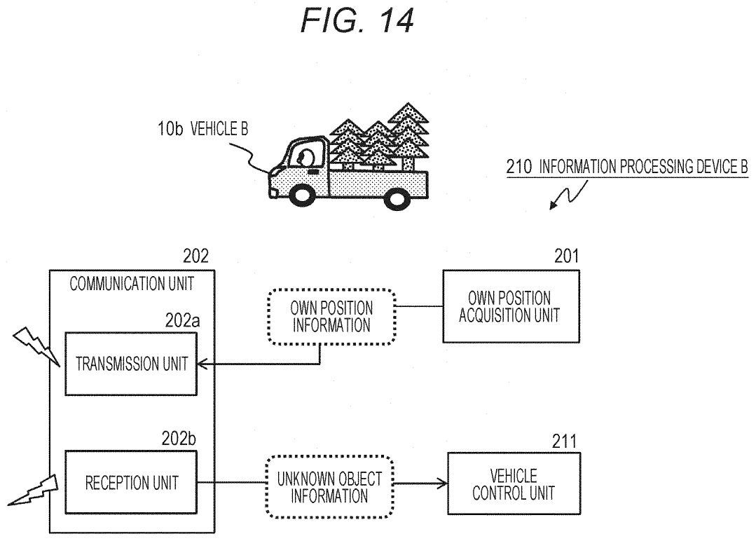

The configuration of an information processing device 210 mounted on the vehicle B, 10b will be described with reference to FIG. 14.

As shown in FIG. 14, the information processing device 210 mounted on the vehicle B, 10b has an own position acquisition unit 201, a communication unit 202, and the vehicle control unit 211. The communication unit 202 includes a transmission unit 202a that performs multicast transmission and the like, for example, and a reception unit 202b that performs reception processing of unicast communication data, for example.

The own position acquisition unit 201 acquires the own position by using GPS, a dynamic map provided by the management server 20, or the like. The acquired own position information is multicast-transmitted together with other vehicle information through the transmission unit 202a of the communication unit 202.

The vehicle information transmitted by multicast is the data described above with reference to FIG. 7(B), for example.

The reception unit 202b of the communication unit 202 receives, for example, “unknown object information” unicast-transmitted by another surrounding vehicle.

The “unknown object information” received by the reception unit 202b of the communication unit 202 is input to the vehicle control unit 211.

Upon receipt of the “unknown object information”, the vehicle control unit 211 performs travel control of the vehicle B, 10b, specifically, processing of deceleration, stop, and the like.

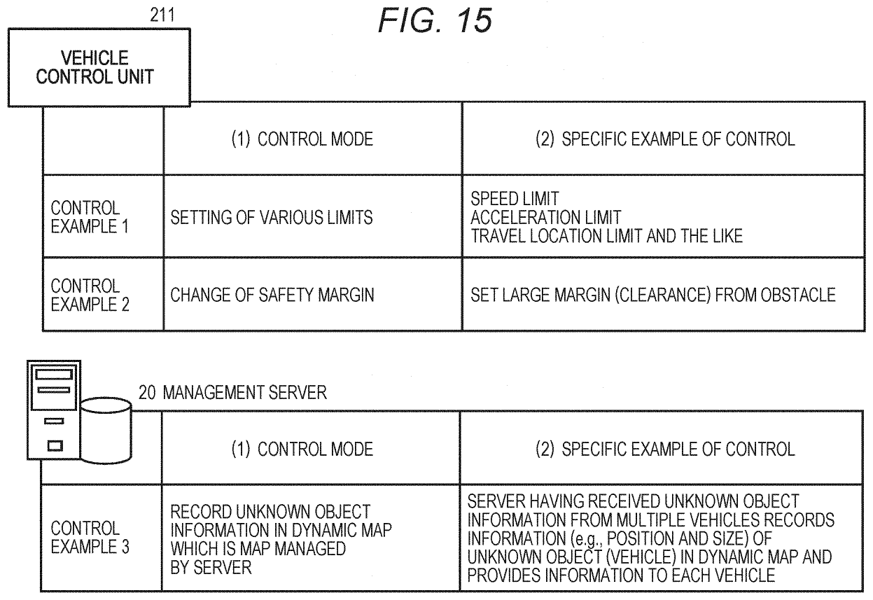

A specific example of the processing performed by the vehicle control unit 211 will be described with reference to FIG. 15.

The vehicle control unit 211 performs processing of at least one of Control example 1 or Control example 2 shown in FIG. 15.

Control example 1 is a setting of various limits such as limit processing including a speed limit, an acceleration limit, and a travel location limit. Speed limit is processing of limiting the traveling at a certain speed or less, and includes stop processing. Acceleration limit is processing of limiting acceleration beyond the current speed. Travel location limit is processing of limiting the traveling path such as only in the left lane.

By performing such travel control by the vehicle control unit 211, it is possible to reduce the possibility of a collision due to sudden acceleration, speed change, travel route change, or the like.

Control example 2 is a change of the safety margin, and is processing of increasing the margin (clearance) from an obstacle, for example. Autonomous driving vehicles and vehicles equipped with a driving assistance mechanism are equipped with a mechanism that performs processing such as stopping when approaching an obstacle to a predetermined distance and sounding an alert, in order to avoid collision or contact of the vehicle. The vehicle control unit 211 performs processing of increasing the predetermined distance, that is, the margin.

This processing can reduce the possibility of collision with obstacles and other vehicles.

FIG. 15 further shows the processing of a management server 20 at the bottom.

For example, if the vehicle B, 10b cannot receive data transmitted from the vehicle A, 10a, the vehicle control by the vehicle control unit 211 of the vehicle B, 10b is not performed.

In such a case, the management server 20 adds information indicating that the vehicle B, 10b is an unknown object or is a dangerous vehicle to the dynamic roadmap generated and updated by the management server.

This information is information that can be referred to by each vehicle at any time. For example, in a case where the vehicle B, 10b approaches the vicinity of the vehicle, it becomes possible to check the position, size, and the like of the vehicle B, 10b on the basis of the dynamic roadmap.

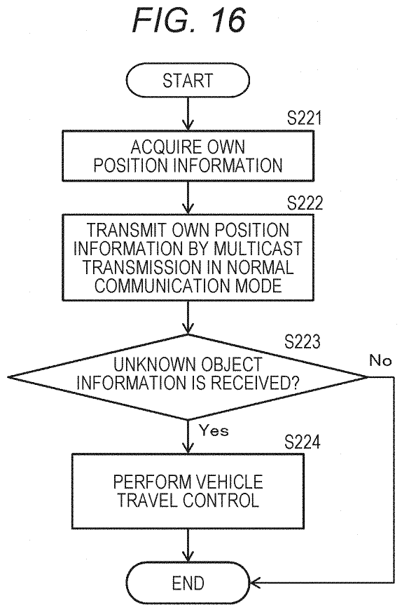

Next, referring to the flowchart shown in FIG. 16, the processing sequence performed by the information processing device B, 210 shown in FIG. 14, that is, the information processing device B, 210 mounted on the vehicles B, 10b will be described.

(Step S221)

First, the information processing device B, 200 acquires the own position information.

This processing is processing performed by the own position acquisition unit 20 shown in FIG. 14.

The own position acquisition unit 201 acquires the own position by using GPS, a dynamic map provided by the management server 20, or the like.

(Step S222)

Next, in step S222, the own position information acquired in step S221 is multicast-transmitted in the normal communication mode.

This multicast transmission data is the data described above with reference to FIG. 7(B), and includes the following data, for example.

Source ID (own ID)=address information for communication such as vehicle identifier (vehicle ID), IP address, and MAC address.

Own position, speed, posture=information regarding the position, speed, and posture of the vehicle.

Vehicle type information=property information of the vehicle such as vehicle type, size, and body texture.

Control information=information regarding control and planning of the vehicle, such as target position, target speed, and planned route.

Sensor information=acquired information from various sensors such as a camera, a LIDAR (laser-type range sensor), a sonar, and an inertial measurement unit (IMU).

(Step S223)

Next, in step S223, it is determined whether or not “unknown object information” has been received.

For example, the “unknown object information” is “unknown object information” transmitted in step S108 described with reference to the flowchart shown in FIG. 11.

If it is determined in step S223 that “unknown object information” has not been received, the processing ends.

On the other hand, if it is determined in step S223 that “unknown object information” has been received, the processing proceeds to step S224.

(Step S224)

If it is determined in step S223 that “unknown object information” has been received, vehicle control is performed in step S224.

This processing is processing performed by the vehicle control unit 211 shown in FIG. 14.

The vehicle control unit 211 performs the processing described above with reference to FIG. 15 such as processing of speed limiting, acceleration limiting, travel location limiting, and margin increase, which are travel control effective for reducing the possibility of self-induced collision with other vehicles, for example.

### 5. Example (Example 3) of Transmitting Vehicle Control Information to Unknown Vehicle to Perform Remote Control of Other Vehicle

Next, as Example 3, an example in which vehicle control information is transmitted to an unknown vehicle to perform remote control of the other vehicle will be described.

In Example 2 described above, in a case where the vehicle A, 10a determines that the vehicle B, 10b is an unknown object in the image analysis, the vehicle A, 10a transmits “unknown object information” to the vehicle B, 10b, and upon receipt of the “unknown object information”, the vehicle B, 10b performs travel control by itself.

In Example 3 described below, in a case where a vehicle A, 10a determines that a vehicle B, 10b is an unknown object in the image analysis, the vehicle A, 10a transmits “vehicle control information” to the vehicle B, 10b. The vehicle B, 10b performs travel control of the vehicle B, 10b on the basis of the received “vehicle control information”. That is, the vehicle A, 10a directly remote-controls the traveling of the vehicle B, 10b.

Hereinafter, this Example 3 will be described.

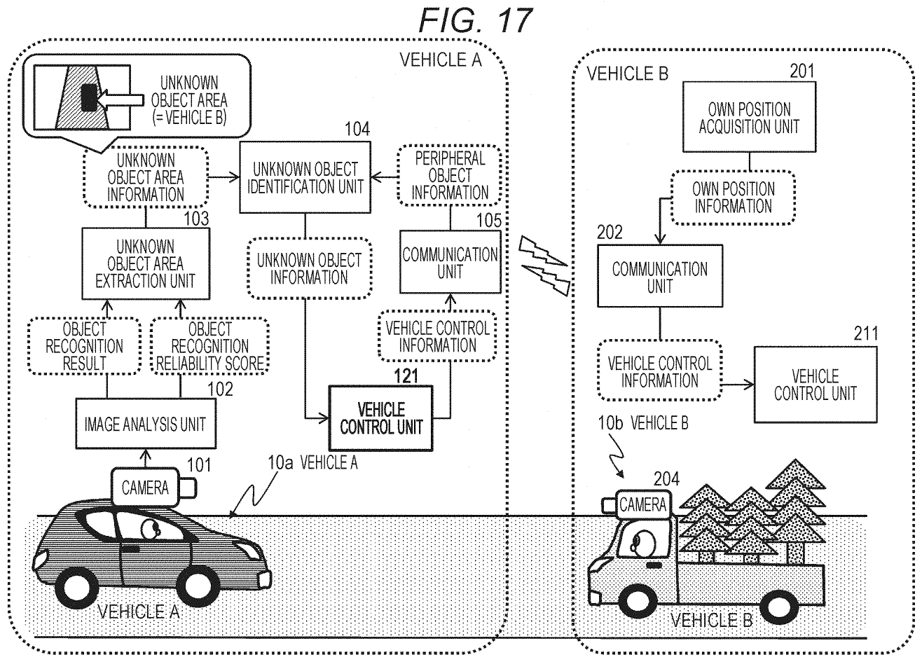

FIG. 17 is a diagram showing a configuration example of an information processing device mounted on a vehicle of Example 3. Similar to the example described above, an example will be described of processing in which the vehicle A, 10a and the vehicle B, 10b communicate with each other using vehicle-to-vehicle communication (V2V communication) in a situation where the vehicle A, 10a on the left side in FIG. 17 is traveling and approaching the vehicle B, 10b on the right side in FIG. 17.

In Example 3, the information processing device mounted on the vehicle A, 10a has a configuration in which a vehicle control unit 121 is added to the configuration described above with reference to FIG. 2. The information processing device mounted on the vehicle B, 10b is similar to that of Example 2 described above with reference to FIGS. 113 and 14. Note, however, that a vehicle control unit 211 of the vehicle B, 10b performs vehicle control according to vehicle control information (remote control information) received from the vehicle A, 10a.

Processing of the vehicle control unit 121 of the vehicle A, 10a will be described.

The vehicle control unit 121 of the vehicle A, 10a generates vehicle control information to be transmitted to an unknown object identified by an unknown object identification unit 104, that is, an unknown vehicle, and transmits the vehicle control information to the vehicle B, 10b through a communication unit 105 (unicast transmission).

The vehicle control information to be transmitted is information for causing the vehicle B, 10b to perform the control shown in Control examples 1 and 2 described above with reference to FIG. 15. That is, the vehicle control information is control information for causing the vehicle B, 10b to perform deceleration or stop by speed limiting, acceleration limiting, travel location limiting, processing of increasing a margin from an obstacle, or the like.

These pieces of vehicle control information are transmitted to the vehicle B, 10b through the communication unit 105 of the vehicle A, 10a.

A communication unit 202 of the vehicle B, 10b inputs the vehicle control information received from the vehicle A, 10a to the vehicle control unit 211.

The vehicle control unit 211 controls the vehicle B, 10b according to the vehicle control information received from the vehicle A, 10a.

Specifically, deceleration or stop by speed limiting, acceleration limiting, travel location limiting, processing of increasing a margin from an obstacle, or the like is performed.

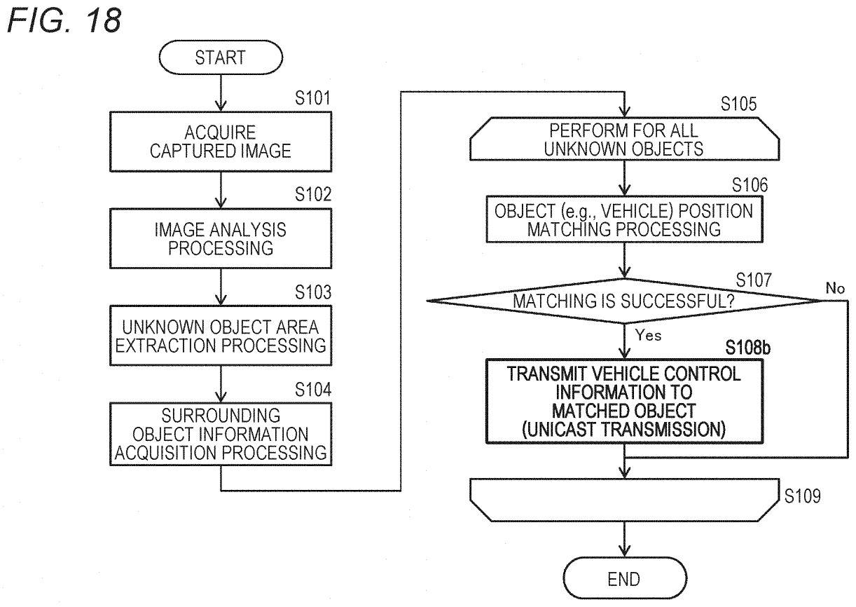

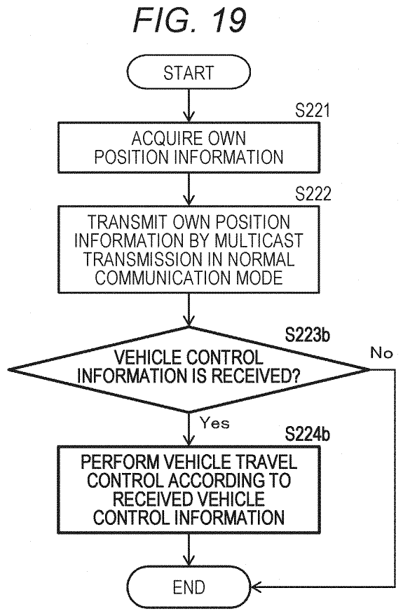

The processing sequence performed by the information processing devices mounted on the vehicle A, 10a and the vehicle B, 10b of Example 3 will be described with reference to the flowcharts shown in FIGS. 18 and 19.

The flowchart shown in FIG. 18 is a flowchart illustrating the processing sequence performed by an information processing device A mounted on the vehicle A, 10a shown in FIG. 17.

Additionally, the flowchart shown in FIG. 19 is a flowchart illustrating the processing sequence performed by an information processing device mounted on the vehicle B, 10b shown in FIG. 17.

The processing according to the flowcharts shown in FIGS. 18 and 19 can be performed according to a program stored in a storage unit of the information processing device, for example.

First, referring to the flowchart shown in FIG. 18, the processing sequence performed by the information processing device A mounted on the vehicle A, 10a shown in FIG. 17 will be described.

Hereinafter, the processing of each step of the flowchart will be described.

Note that the flowchart shown in FIG. 18 is generally similar to the flow shown in FIG. 11 described above as the processing sequence of Example 1, and the difference is that the processing in step S108 of the flow shown in FIG. 11 is replaced with the processing of step S108b of the flow shown in FIG. 18. Other processing is processing similar to that of the flow shown in FIG. 11.

Hereinafter, this difference will mainly be described.

(Steps S101 to S107) Since the processing of steps S101 to S107 is similar to those of steps S101 to S107 of the flow shown in FIG. 11 described above as the processing sequence of Example 1, the description thereof will be omitted.

Note that the processing of steps S105 to S109 are processing that are executed sequentially or in parallel for all the unknown object areas extracted in step S103.

(Step S108b)

Next, the processing of step S108b, which is processing unique to Example 3, will be described.

Step S108b is processing to be performed if matching is successful, that is, a peripheral object matching the unknown object area can be detected in steps S106 to S107.

In step S108b, a peripheral object that matches the unknown object area is identified, and “vehicle control information” is transmitted to the identified object such as an identified vehicle.

The processing of step S108 is processing performed by the unknown object identification unit 104 and the vehicle control unit 121 of the vehicle A, 10a shown in FIG. 17.

The unknown object identification unit 104 identifies a peripheral object that matches the unknown object area, acquires an address for transmitting data to the identified vehicle that is the identified peripheral object, and sets the acquired address to transmit “vehicle control information” to the identified vehicle.

Note that the address is acquired from the multicast communication data received from the identified vehicle.

The vehicle control unit 121 generates vehicle control information to be transmitted to the unknown object identified by the unknown object identification unit 104, that is, the unknown vehicle, and transmits the vehicle control information to the vehicle B, 10b through the communication unit 105 (unicast transmission).

The vehicle control information to be transmitted is remote control information for causing the vehicle B, 10b to perform the control shown in Control examples 1 and 2 described above with reference to FIG. 15. That is, the vehicle control information is specific control information for causing the vehicle B. 10b to perform deceleration or stop by speed limiting, acceleration limiting, travel location limiting, processing of increasing a margin from an obstacle, or the like.

These pieces of vehicle control information are transmitted to the vehicle B, 10b through the communication unit 105 of the vehicle A, 10a.

Next, referring to the flowchart shown in FIG. 19, the processing sequence performed by the information processing device B mounted on the vehicle B, 10b shown in FIG. 17 will be described.

Note that the flow shown in FIG. 19 is a flow obtained by partially changing the flow shown in FIG. 16 described above as Example 2. The difference is that the steps S223 to S224 of the flow shown in FIG. 16 are changed to steps S223b to S224b of the flow shown in FIG. 19.

Hereinafter, the processing of each step of the flow shown in FIG. 19 will be described.

(Step S221)

First, the information processing device B, 200 acquires the own position information.

This processing is processing performed by an own position acquisition unit 20 of the vehicle B, 10b shown in FIG. 17.

The own position acquisition unit 201 acquires the own position by using GPS, a dynamic map provided by the management server 20, or the like.

(Step S222)

Next, in step S222, the own position information acquired in step S221 is multicast-transmitted in the normal communication mode.

This multicast transmission data is the data described above with reference to FIG. 7(B), and includes the following data, for example.

Source ID (own ID)=address information for communication such as vehicle identifier (vehicle ID), IP address, and MAC address.

Own position, speed, posture=information regarding the position, speed, and posture of the vehicle.

Vehicle type information=property information of the vehicle such as vehicle type, size, and body texture.

Control information=information regarding control and planning of the vehicle, such as target position, target speed, and planned route.

Sensor information=acquired information from various sensors such as a camera, a LIDAR (laser-type range sensor), a sonar, and an inertial measurement unit (IMU).

(Step S223b)

Next, in step S223b, it is determined whether or not “vehicle control information” has been received.

For example, the “vehicle control information” is “vehicle control information” transmitted in step S108b described with reference to the flowchart shown in FIG. 18.

If it is determined in step S223b that “vehicle control information” has not been received, the processing ends.

On the other hand, if it is determined in step S223b that the “vehicle control information” has been received, the processing proceeds to step S224b.

(Step S224b)

If it is determined in step S223b that “vehicle control information” has been received, vehicle control is performed in step S224b.

This processing is processing performed by the vehicle control unit 211 shown in FIG. 17.

The vehicle control unit 211 performs vehicle control according to vehicle control information (remote control information) received from the vehicle A, 10a. This vehicle control information is vehicle control information generated by the vehicle control unit 121 of the vehicle A, 10a. That is, the vehicle B, 10b is controlled according to the vehicle control information generated by the vehicle control unit 121 of the vehicle A, 10a.

This vehicle control is control for reducing the possibility of self-induced collision or the like with another vehicle, such as processing of speed limiting, acceleration limiting, travel location limiting, and margin increase, which have been described above with reference to FIG. 15.

### 6. Example (Example 4) of Determining Necessity of Information Transmission to Unknown Vehicle and Transmitting Information Only when Transmission is Necessary

Next, as Example 4, an example in which the necessity of information transmission to an unknown vehicle is determined and information transmission is performed only when the transmission is necessary will be described.

In Examples 1 to 3 described above, examples in which “unknown object information” or “vehicle control information” is transmitted to an identified vehicle determined to be an unknown object have been described.

The example described below is a modification of Examples 1 to 3, and is an example in which it is determined whether or not transmission of “unknown object information” or “vehicle control information” is necessary and information transmission is performed only when it is determined that the transmission is necessary.

Example 4 can be performed together with the above-mentioned Examples 1 to 3.

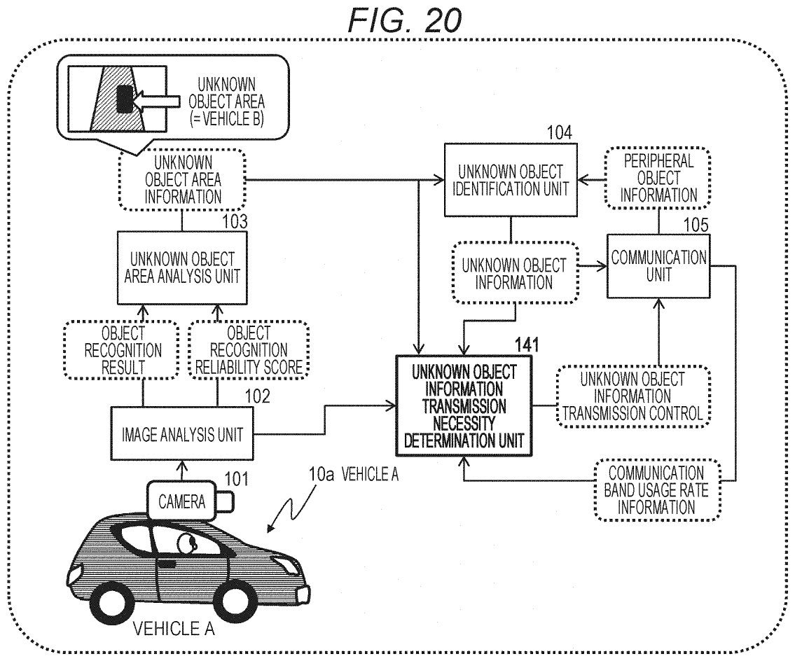

Example 4 will be described with reference to FIG. 20 and following drawings.

Note that while an example of transmitting “unknown object information” will be described in the following description, this example can also be applied to a case of transmitting “vehicle control information”.

FIG. 20 is a diagram showing the configuration of an information processing device A mounted on a vehicle A, 10a that performs processing of Example 4.

The configuration shown in FIG. 20 is a configuration in which an unknown object information transmission necessity determination unit 141 is added to the configuration of the information processing device A of the vehicle A, 10a described above with reference to FIGS. 2 and 9.

Other configurations are similar to those of the information processing device A of the vehicle A, 10a described above with reference to FIGS. 2 and 9.

The unknown object information transmission necessity determination unit 141 receives unknown object information from an unknown object identification unit 104, receives communication band usage rate information from a communication unit 105, and based on these pieces of input information, determines whether or not to transmit the “unknown object information” to the unknown object.

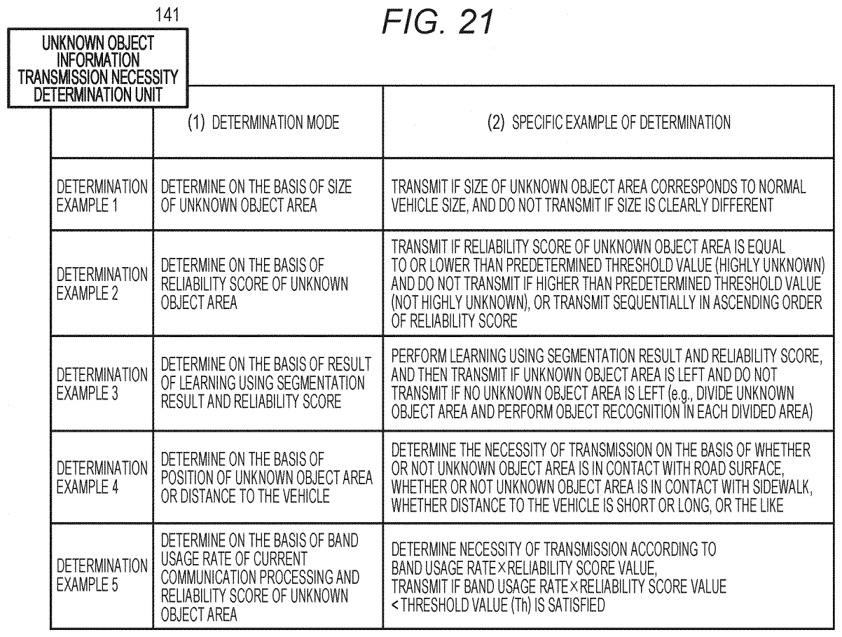

A specific example of information transmission necessity determination processing performed by the unknown object information transmission necessity determination unit 141 will be described with reference to FIG. 21.

FIG. 21 shows multiple specific examples of the information transmission necessity determination processing performed by the unknown object information transmission necessity determination unit 141. The unknown object information transmission necessity determination unit 141 performs at least one of the determination processing of Determination examples 1 to 5 shown in FIG. 21.

Determination example 1 is a processing example of determining the necessity of transmitting information (unknown object information) on the basis of the size of the unknown object area.

For example, if the size of the unknown object area corresponds to a normal vehicle size, it is determined that the information should be transmitted, and if the size is clearly different, the information is not transmitted.

Determination example 2 is a processing example of determining the necessity of transmitting information (unknown object information) on the basis of the object recognition reliability score of the unknown object area.

For example, if the object recognition reliability score of the unknown object area is equal to or lower than a predetermined threshold value (highly unknown), the information is transmitted. Meanwhile, if the object recognition reliability score of the unknown object is higher than the predetermined threshold (not highly unknown), the information is not transmitted. Alternatively, the information may be transmitted sequentially in ascending order of reliability score.

Determination example 3 is a processing example of determining the necessity of transmitting information (unknown object information) on the basis of a result of learning using a segmentation result and the object recognition reliability score of the unknown object area.

For example, learning using the segmentation result and the reliability score is performed to sequentially resolve the unknown object areas, and if an unknown object area is left after this processing, the information is transmitted. If no unknown object area is left, the information is not transmitted. Specifically, for example, processing of dividing an unknown object area and performing object recognition in each divided area is performed.

Determination example 4 is a processing example of determining the necessity of transmitting information (unknown object information) on the basis of the position of the unknown object area or the distance to the vehicle.

For example, the necessity of transmission is determined on the basis of whether or not the unknown object area is in contact with the road surface, whether or not the unknown object is in contact with the sidewalk, or whether the distance to the vehicle is short or long.

Determination example 5 is a processing example of determining on the basis of the band usage rate of the communication processing currently performed by the communication unit and the object recognition reliability score of the unknown object area.

For example, the necessity of transmission is determined according to the value of band usage rate×object recognition reliability score. Specifically,

band usage rate×object recognition reliability score value<threshold value (Th)

If the above determination formula is satisfied, the information is transmitted, and if not, the information is not transmitted.

The unknown object information transmission necessity determination unit 141 performs at least one of the processing of Determination examples 1 to 5 shown in FIG. 21 in this way to determine the necessity of transmitting information (unknown object information).

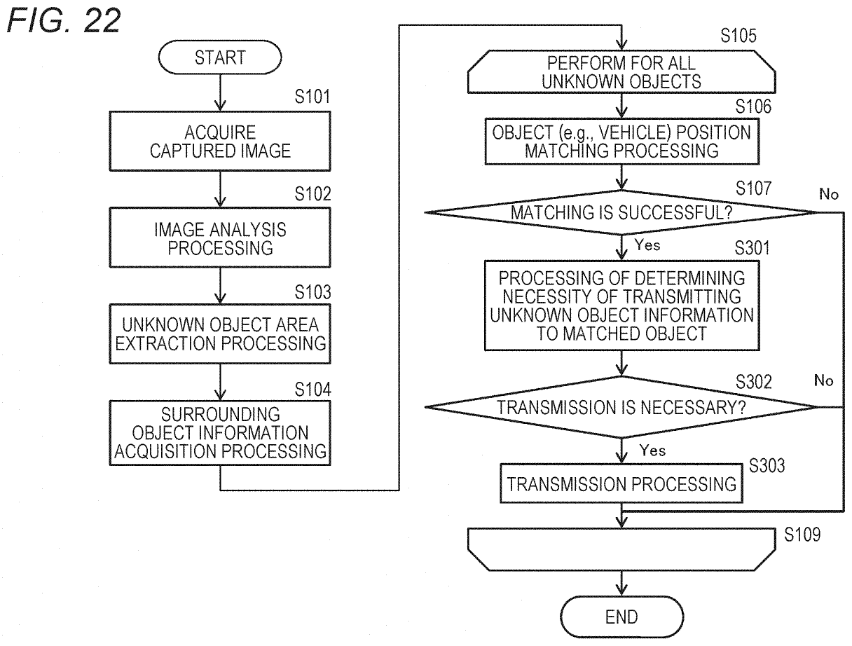

Next, referring to the flowchart shown in FIG. 22, the processing sequence performed by the information processing device A mounted on the vehicle A, 10a of Example 4 shown in FIG. 20 will be described.

Hereinafter, the processing of each step of the flowchart will be described.

Note that the flowchart shown in FIG. 22 is generally similar to the flow shown in FIG. 11 described above as the processing sequence of Example 1, and the difference is that the processing in step S108 of the flow shown in FIG. 11 is replaced with the processing of steps S301 to S303 of the flow shown in FIG. 22. Other processing is processing similar to that of the flow shown in FIG. 11.

Hereinafter, this difference will mainly be described.

(Steps S101 to S107)

Since the processing of steps S101 to S107 is similar to those of steps S101 to S107 of the flow shown in FIG. 11 described above as the processing sequence of Example 1, the description thereof will be omitted.

Note that the processing of steps S105 to S109 are processing that are executed sequentially or in parallel for all the unknown object areas extracted in step S103.

(Step S301)

Next, the processing of step S301, which is processing unique to Example 4, will be described.

Step S301 is processing to be performed if matching is successful, that is, a peripheral object matching the unknown object area can be detected in steps S106 to S107.

In step S301, transmission necessity determination processing for determining whether or not to transmit “unknown object information” is performed for an identified matched object, that is, an identified vehicle which is a peripheral object matching the unknown object area.

The processing of step S301 is processing performed by the unknown object information transmission necessity determination unit 141 of the vehicle A, 10a shown in FIG. 20.

The unknown object information transmission necessity determination unit 141 performs at least one of the determination processing of Determination examples 1 to 5 described above with reference to FIG. 21, and determines whether or not to transmit the “unknown object information” to the identified vehicle.

(Steps S302 to S303)

In the determination processing of step S301, if the unknown object information transmission necessity determination unit 141 determines that “unknown object information” needs to be transmitted to the identified vehicle (step S302=Yes), the processing proceeds to step S303, and in step S303, “unknown object information” is transmitted to the identified vehicle.

On the other hand, in the determination processing of step S301, if the unknown object information transmission necessity determination unit 141 determines that “unknown object information” does not need to be transmitted to the identified vehicle (step S302=Yes), the processing ends without performing the “unknown object information” transmission processing in step S303.

By performing these processing, the transmission processing of “unknown object information” is performed only if specific conditions are met, such as when the object detected by image analysis is highly unknown, or if the band usage rate of communication is low and there is a margin in available communication band. Hence, less necessary transmission of information is curbed, and the occurrence of communication congestion and the like can be prevented.

Note that while the above-mentioned Example 4 describes a transmission example of “unknown object information”, Example 4 can also be applied to a case of transmitting “vehicle control information”.

### 7. Example (Example 5) of Performing Processing Using Information Acquired from Multiple Vehicles

Next, as Example 5, an example of performing processing using information acquired from multiple vehicles will be described.

Example 5 is an example that can be performed together with the above-mentioned processing of Examples 1 to 4.

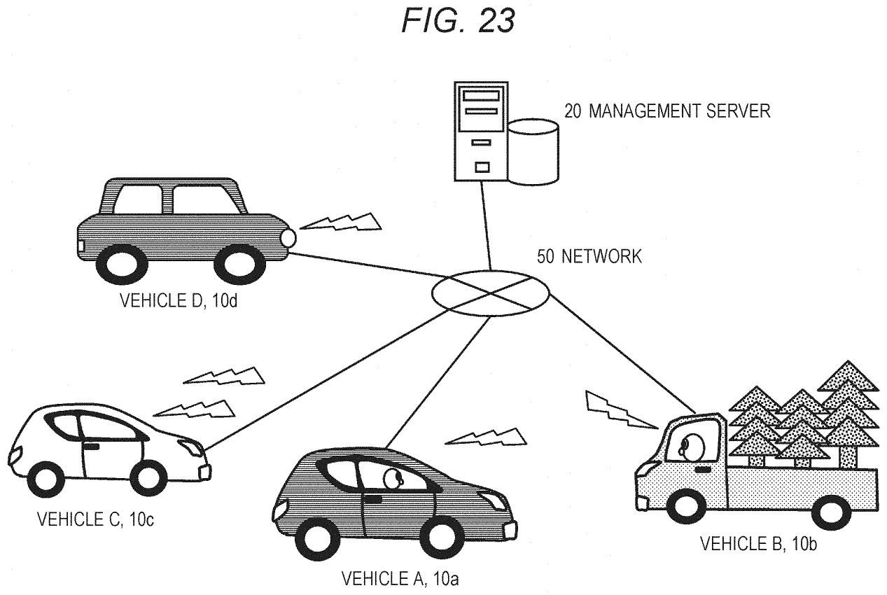

Example 5 will be described with reference to FIG. 23.

Examples 1 to 4 have been described as examples in which one vehicle A, 10a determines that the vehicle B, 10b is an unknown object and transmits various information (unknown object information or vehicle control information) to the vehicle B, 10b.

Considering the actual traffic conditions, as shown in FIG. 23, for example, the vehicle that determines that a vehicle B, 10b is an unknown object is not only one vehicle A, 10a, but is assumed to be multiple vehicles including a vehicle C, 10c and a vehicle D, 10d traveling in the vicinity thereof.

It is assumed that all of these multiple vehicles determine that the vehicle B, 10b is an unknown object.

In a case where multiple vehicles determine that the vehicle B, 10b is an unknown object in this way, each vehicle transmits information (unknown object information or vehicle control information) to the vehicle B, 10b.

In a case where the vehicle B, 10b receives the unknown object information from these multiple vehicles, the vehicle B, 10b performs multicast transmission with a higher degree of urgency than a case where the unknown object information is received from only one vehicle. That is, processing such as selective transmission of highly important data and increase in transmission frequency is performed. Note that highly important data is position data or size information, for example.

As described above, transmission priority information is preset for each piece of data to be multicast-transmitted, and a communication control unit of the vehicle B, 10b preferentially selects and transmits data having a higher transmission priority from among the pieces of data.

By performing such processing, it is possible to reliably notify multiple vehicles of only important vehicle information of the vehicle B, 10b.

Additionally, in a case where the vehicle B, 10b receives “vehicle control information” from multiple vehicles, the following processing is performed.

In a case where the same “vehicle control information” is received from multiple vehicles, processing is performed according to the common “vehicle control information”.

Additionally, as processing in a case where pieces of “vehicle control information” having different contents are received from multiple vehicles, it is preferable to perform processing such as emergency stop processing.

Alternatively, if the position of each vehicle that has transmitted the vehicle control information can be estimated, the control may be performed according to the vehicle control information received from one vehicle at the closest distance.

Moreover, a management server 20 may receive information, that is, “unknown object information” or “vehicle control information”, transmitted by multiple vehicles, and the management server 20 may analyze the position of the vehicle B, 10b on the basis of the information from the vehicles and provide the analyzed position information to the vehicles.

Additionally, if the management server 20 can receive vehicle information from the vehicle B, 10b which is regarded as an unknown object, the management server 20 may be configured to provide the vehicle information to each of the other vehicles.

For example, the management server 20 generates and updates a dynamic map that reflects the current traffic conditions on the map, and also performs map update processing for recording details of unknown objects on the dynamic map on the basis of unknown object information transmitted by each vehicle.

Each vehicle can confirm details of an unknown object by referring to the dynamic map updated by the management server 20.

Note that the management server 20 can record detailed information of a vehicle corresponding to an unknown object on the basis of vehicle information received from the vehicle corresponding to the unknown object.

[8. Configuration Example of Information Processing Device]

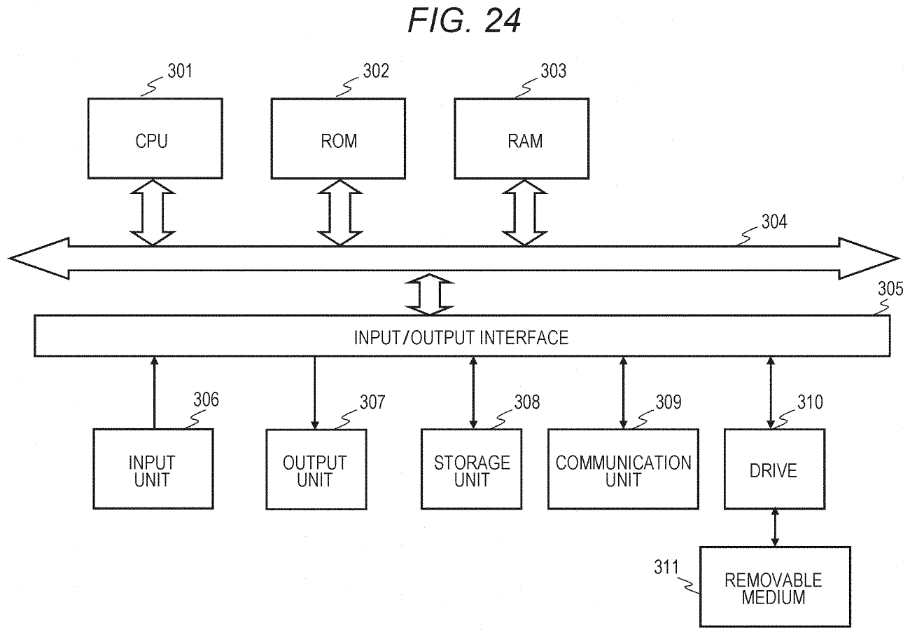

Next, a specific hardware configuration example of the information processing device that performs the above-described processing will be described with reference to FIG. 24. An example of a hardware configuration applicable as an information processing device mounted on the vehicle A, 10a and the vehicle B, 10b will be described.

FIG. 24 is a diagram showing the hardware configuration example of the information processing device.

The central processing unit (CPU) 301 functions as a data processing unit that performs various processing according to a program stored in a read only memory (ROM) 302 or a storage unit 308. For example, the processing according to the sequences described in the above examples is executed. A random access memory (RAM) 303 stores programs and data executed by the CPU 301, for example. The CPU 301, the ROM 302, and the RAM 303 are mutually connected by a bus 304.

The CPU 301 is connected to an input/output interface 305 through the bus 304. The input/output interface 305 is connected to an input unit 306 including various switches, a keyboard, a touch panel, a mouse, a microphone, and a data acquisition unit such as a sensor, a camera, and GPS, and an output unit 307 including a display and a speaker. Note that the output unit 307 also outputs drive information for a drive unit of a moving device.

The CPU 301 receives input of commands, status data, and the like input from the input unit 306, performs various processing, and outputs the processing results to the output unit 307, for example.

The storage unit 308 connected to the input/output interface 305 includes, for example, a hard disk or the like, and stores programs and various data executed by the CPU 301. A communication unit 309 functions as a transmission/reception unit for data communication through a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and records or reads data.

### 9. Summary of Configuration of Present Disclosure

As described above, the examples of the present disclosure have been described in detail with reference to the specific examples. However, it is self-evident a person skilled in the art can modify or substitute the examples without departing from the gist of the present disclosure. That is, the present invention has been disclosed in the form of an example, and should not be construed in a limited manner. In order to determine the gist of the present disclosure, the column of claims should be taken into consideration.

Note that the technology disclosed in the present specification can have the following configurations.

(1) An information processing device including:

an image analysis unit that analyzes an image captured by a camera mounted on a moving device and performs object recognition in the image;

an unknown object identification unit that identifies an unknown object in an image area determined to be an unknown object area as a result of analysis by the image analysis unit; and

a communication unit that transmits information to an unknown object identified by the unknown object identification unit, in which

the unknown object identification unit identifies an unknown object in an image area determined to be an unknown object area by using peripheral object information received through the communication unit.

(2)

The information processing device according to (1), in which

the communication unit transmits, to an unknown object identified by the unknown object identification unit, unknown object information indicating that the unknown object has been determined as an unknown object.

(3)

The information processing device according to (1) or (2), in which

an unknown object identified by the unknown object identification unit is a second moving device, and

the communication unit transmits control information for performing movement control of the second moving device to the second moving device.

(4)

The information processing device according to any one of (1) to (3), in which

an unknown object identified by the unknown object identification unit is a second moving device, and

the communication unit transmits remote control information for performing remote control of the second moving device to the second moving device.

(5)

The information processing device according to any one of (1) to (4), in which

the unknown object identification unit identifies an unknown object in an image area determined to be an unknown object area by using peripheral object information received through the communication unit.

(6)

The information processing device according to (5), in which

the peripheral object information includes received information from the unknown object.

(7)

The information processing device according to (5) or (6), in which

the peripheral object information includes received information from the unknown object, the received information including address information usable in communication with the unknown object, and

the communication unit transmits information to the unknown object by using the address information.

(8)

The information processing device according to any one of (1) to (7) further including

an information transmission necessity determination unit that determines the necessity of information transmission to the unknown object through the communication unit, in which

the information transmission necessity determination unit determines the necessity of information transmission on the basis of at least one of a size of an unknown object, a reliability score of object recognition by the image analysis unit, a distance to the moving device, or a current communication status.

(9)

An information processing device including:

an own position acquisition unit that acquires a current position of a moving device;

a communication unit that transmits moving device information including own position information acquired by the own position acquisition unit; and

a communication control unit that, upon receipt of unknown object information through the communication unit, changes a mode of transmitting moving device information through the communication unit.

(10)

The information processing device according to (9), in which

upon receipt of unknown object information through the communication unit, the communication control unit changes a mode of transmitting moving device information through the communication unit from a normal communication mode to an emergency communication mode.

(11)

The information processing device according to (9) or (10), in which

upon receipt of unknown object information through the communication unit, the communication control unit selects and transmits only information having a high transmission priority according to a transmission priority associated with pieces of information included in the moving device information.

(12)

The information processing device according to any one of (9) to (11), in which

upon receipt of unknown object information through the communication unit, the communication control unit performs communication mode change processing for increasing at least one of transmission frequency, transmission band, or transmission output of the moving device information to be higher than in normal times.

(13)

An information processing device including:

an own position acquisition unit that acquires a current position of a moving device;

a communication unit that transmits moving device information including own position information acquired by the own position acquisition unit; and

a moving device control unit that, upon receipt of unknown object information or moving device control information through the communication unit, performs movement control of the moving device.

(14)

The information processing device according to (13), in which

the moving device control unit performs at least one of speed control, acceleration control, or travel location control of the moving device, or control of a margin which is a distance from an obstacle.

(15)

The information processing device according to (13) or (14), in which

the moving device control information received through the communication unit is moving device control information for performing remote control of the moving device, and

the moving device control unit performs moving device control according to moving device control information which is remote control information.

(16)

An information processing system including

a management server that generates and updates a dynamic map that reflects traffic information on a map, and

a moving device that refers to the dynamic map, in which

the management server performs map update processing for recording details of an unknown object on the dynamic map on the basis of unknown object information transmitted by the moving device, and

the moving device is allowed to confirm details of the unknown object by referring to the updated dynamic map.

(17)

The information processing system according to (16), in which

the management server records the details of the unknown object on the dynamic map on the basis of moving device information received from a moving device corresponding to the unknown object.

(18)

An information processing method performed by an information processing device, the method including:

an image analysis step in which an image analysis unit analyzes an image captured by a camera mounted on a moving device and performs object recognition in the image;

an unknown object identification step in which an unknown object identification unit identifies an unknown object in an image area determined to be an unknown object area as a result of analysis by the image analysis unit; and

a communication step in which a communication unit transmits information to an unknown object identified by the unknown object identification unit, in which

the unknown object identification step identifies an unknown object in an image area determined to be an unknown object area by using peripheral object information received through the communication unit.

(19)

An information processing method performed by an information processing device, the method including:

an own position acquisition step in which an own position acquisition unit acquires a current position of a moving device;

a communication step in which a communication unit transmits moving device information including own position information acquired by the own position acquisition unit; and

a communication control step in which, upon receipt of unknown object information through the communication unit, a communication control unit changes a mode of transmitting of moving device information through the communication unit.

(20)

An information processing method performed by an information processing device, the method including:

an own position acquisition step in which an own position acquisition unit acquires a current position of a moving device;

a communication step in which a communication unit transmits moving device information including own position information acquired by the own position acquisition unit; and

a moving device control step in which, upon receipt of unknown object information or moving device control information through the communication unit, a moving device control unit performs movement control of the moving device.

The series of processing described in the specification can be performed by hardware, software, or a combined configuration of both. In the case of performing processing by software, a program in which a processing sequence is recorded can be installed and executed in a memory of a computer incorporated in dedicated hardware, or the program can be installed and executed by a general-purpose computer that can execute various processing. For example, the program can be pre-recorded on a recording medium. In addition to installing on a computer from a recording medium, the program can be received through a network such as a local area network (LAN) and the Internet and be installed on a recording medium such as a built-in hard disk.

Note that the various processing described in the specification is not only performed in chronological order according to the description, but may also be performed in parallel or individually by the processing capacity of the device that performs the processing or as necessary. Additionally, in the present specification, a system is a logical set configuration of multiple devices, and the devices having the configurations do not necessarily have to be in the same housing.

### INDUSTRIAL APPLICABILITY

As described above, according to the configuration of one example of the present disclosure, a device and a method that enable safe driving by performing object recognition using image analysis and inter-vehicle communication information are implemented.

Specifically, for example, provided are an image analysis unit that analyzes an image captured by a vehicle-mounted camera and performs object recognition in the image, an unknown object identification unit that identifies an unknown object in an image area determined to be an unknown object area as a result of analysis by the image analysis unit, and a communication unit that transmits information to an unknown object such as a second vehicle identified by the unknown object identification unit. The unknown object identification unit identifies the second vehicle, which is an unknown object in the image area determined to be the unknown object area, using the peripheral object information received through the communication unit. The communication unit transmits unknown object information or control information for travel control of the second vehicle to the second vehicle.

With this configuration, a device and a method that enable safe driving by performing object recognition using image analysis and inter-vehicle communication information are implemented.

### REFERENCE SIGNS LIST

10 Vehicle
20 Management server
30 Roadside communication unit (RSU)
50 Network
100 Information processing device A
101 Camera (imaging unit)
102 Image analysis unit
103 Unknown object area extraction unit
104 Unknown object identification unit
105 Communication unit
121 Vehicle control unit
141 Unknown object information transmission necessity
determination unit
200 Information processing device B
201 Own position acquisition unit
202 Communication unit
203 Communication control unit
211 Vehicle control unit
301 CPU
302 ROM
303 RAM
304 Bus
305 Input/output interface
306 Input unit
307 Output unit
308 Storage unit
309 Communication unit
310 Drive
311 Removable medium

1. An information processing device comprising:
an image analysis unit that analyzes an image captured by a camera mounted on a moving device and performs object recognition in the image;
an unknown object identification unit that identifies an unknown object in an image area determined to be an unknown object area as a result of analysis by the image analysis unit; and
a communication unit that transmits information to an unknown object identified by the unknown object identification unit, wherein
the unknown object identification unit identifies an unknown object in an image area determined to be an unknown object area by using peripheral object information received through the communication unit.

2. The information processing device according to claim 1, wherein
the communication unit transmits, to an unknown object identified by the unknown object identification unit, unknown object information indicating that the unknown object has been determined as an unknown object.

3. The information processing device according to claim 1, wherein
an unknown object identified by the unknown object identification unit is a second moving device, and the communication unit transmits control information for performing movement control of the second moving device to the second moving device.

4. The information processing device according to claim 1, wherein
an unknown object identified by the unknown object identification unit is a second moving device, and
the communication unit transmits remote control information for performing remote control of the second moving device to the second moving device.

5. The information processing device according to claim 1, wherein
the unknown object identification unit identifies an unknown object in an image area determined to be an unknown object area by using peripheral object information received through the communication unit.

6. The information processing device according to claim 5, wherein
the peripheral object information includes received information from the unknown object.

7. The information processing device according to claim 5, wherein
the peripheral object information includes received information from the unknown object, the received information including address information usable in communication with the unknown object, and
the communication unit transmits information to the unknown object by using the address information.

8. The information processing device according to claim 1 further comprising
an information transmission necessity determination unit that determines the necessity of information transmission to the unknown object through the communication unit, wherein
the information transmission necessity determination unit determines the necessity of information transmission on a basis of at least one of a size of an unknown object, a reliability score of object recognition by the image analysis unit, a distance to the moving device, or a current communication status.

9. An information processing device comprising:
an own position acquisition unit that acquires a current position of a moving device;
a communication unit that transmits moving device information including own position information acquired by the own position acquisition unit; and
a communication control unit that, upon receipt of unknown object information through the communication unit, changes a mode of transmitting moving device information through the communication unit.

10. The information processing device according to claim 9, wherein
upon receipt of unknown object information through the communication unit, the communication control unit changes a mode of transmitting moving device information through the communication unit from a normal communication mode to an emergency communication mode.

11. The information processing device according to claim 9, wherein
upon receipt of unknown object information through the communication unit, the communication control unit selects and transmits only information having a high transmission priority according to a transmission priority associated with pieces of information included in the moving device information.

12. The information processing device according to claim 9, wherein
upon receipt of unknown object information through the communication unit, the communication control unit performs communication mode change processing for increasing at least one of transmission frequency, transmission band, or transmission output of the moving device information to be higher than in normal times.

13. An information processing device comprising:
an own position acquisition unit that acquires a current position of a moving device;
a communication unit that transmits moving device information including own position information acquired by the own position acquisition unit; and
a moving device control unit that, upon receipt of unknown object information or moving device control information through the communication unit, performs movement control of the moving device.

14. The information processing device according to claim 13, wherein
the moving device control unit performs at least one of speed control, acceleration control, or travel location control of the moving device, or control of a margin which is a distance from an obstacle.

15. The information processing device according to claim 13, wherein
the moving device control information received through the communication unit is moving device control information for performing remote control of the moving device, and
the moving device control unit performs moving device control according to moving device control information which is remote control information.

16. An information processing system comprising
a management server that generates and updates a dynamic map that reflects traffic information on a map, and
a moving device that refers to the dynamic map, wherein
the management server performs map update processing for recording details of an unknown object on the dynamic map on a basis of unknown object information transmitted by the moving device, and
the moving device is allowed to confirm details of the unknown object by referring to the updated dynamic map.

17. The information processing system according to claim 16, wherein
the management server records the details of the unknown object on the dynamic map on a basis of moving device information received from a moving device corresponding to the unknown object.

18. An information processing method performed by an information processing device, the method comprising:
an image analysis step in which an image analysis unit analyzes an image captured by a camera mounted on a moving device and performs object recognition in the image;
an unknown object identification step in which an unknown object identification unit identifies an unknown object in an image area determined to be an unknown object area as a result of analysis by the image analysis unit; and
a communication step in which a communication unit transmits information to an unknown object identified by the unknown object identification unit, wherein
the unknown object identification step identifies an unknown object in an image area determined to be an unknown object area by using peripheral object information received through the communication unit.

19. An information processing method performed by an information processing device, the method comprising:
an own position acquisition step in which an own position acquisition unit acquires a current position of a moving device;
a communication step in which a communication unit transmits moving device information including own position information acquired by the own position acquisition unit; and
a communication control step in which, upon receipt of unknown object information through the communication unit, a communication control unit changes a mode of transmitting moving device information through the communication unit.

20. An information processing method performed by an information processing device, the method comprising:
an own position acquisition step in which an own position acquisition unit acquires a current position of a moving device;
a communication step in which a communication unit transmits moving device information including own position information acquired by the own position acquisition unit; and
a moving device control step in which, upon receipt of unknown object information or moving device control information through the communication unit, a moving device control unit performs movement control of the moving device.
